(19) United States
(12) Patent Application Publication
(10) Pub. No.: US 2024/0113823 A1
(43) Pub. Date: Apr. 4, 2024

(54) TIME-DOMAIN VARIATION FOR SIDELINK REFERENCE SIGNAL TRANSMISSION

(71) Applicant: QUALCOMM Incorporated, San Diego, CA (US)

(72) Inventors: Alexandros MANOLAKOS, Escondido, CA (US); Sony AKKARAKARAN, Poway, CA (US); Kianoush HOSSEINI, San Diego, CA (US)

(21) Appl. No.: 18/257,834

(22) PCT Filed: Feb. 10, 2022
(86) PCT No.: PCT/US2022/015984

§ 371 Date: Jun. 15, 2023

(30) Foreign Application Priority Data
Feb. 11, 2021 (GR) 20210100094

(51) Int. Cl. H04L 5/00; H04W 72/0446; H04W 72/25

(52) U.S. Cl. CPC H04L 5/0048; H04W 72/0446; H04W 72/25

(57) ABSTRACT

Methods, systems, and devices for wireless communications are described. A relay user equipment (UE) may have a sidelink connection established with each UE of a group of UEs. The group of UEs may be configured with a periodic set of sidelink resources for a reference signal measurement associated with reference signals. Each UE of the group may be configured with a periodicity for the sidelink resources, an initial offset in a first instance of the sidelink resources, and a time-domain variation associated with the reference signals to change the offset across instances of the reference signal resource. The relay UE and the UEs of the group may communicate reference signals over the periodic set of sidelink resources according to the time-domain variation associated with the reference signals.

### CROSS REFERENCE

The present Application is a 371 national stage filing of International PCT Application No. PCT/US2022/015984 by MANOLAKOS et al. entitled “TIME-DOMAIN VARIATION FOR SIDELINK REFERENCE SIGNAL TRANSMISSION,” filed Feb. 10, 2022; and claims priority to Greece Patent Application No. 20210100094 by MANOLAKOS et al., entitled “TIME-DOMAIN VARIATION FOR SIDELINK REFERENCE SIGNAL TRANSMISSION,” filed Feb. 11, 2021, each of which is assigned to the assignee hereof, and each of which is expressly incorporated by reference in its entirety herein.

### INTRODUCTION

The following relates to wireless communications, including assigning resources for a sidelink reference signal procedure.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communications at a first UE is described. The method may include transmitting, to a network entity, a request for sidelink resources for a reference signal measurement for a set of multiple UEs, receiving, from the network entity, an indication of a periodic set of sidelink resources for the reference signal measurement associated with a set of multiple reference signals and a time-domain variation associated with the set of multiple reference signals or the reference signal measurement for each UE of the set of multiple UEs, transmitting, to each UE of the set of multiple UEs, an indication of the periodic set of sidelink resources for the reference signal measurement and a respective time-domain variation associated with the set of multiple reference signals for each sidelink resource of the periodic set of sidelink resources, and communicating the set of multiple reference signals over the periodic set of sidelink resources according to the time-domain variation associated with the set of multiple reference signals for each UE of the set of multiple UEs.

An apparatus for wireless communications at a first UE is described. The apparatus may include a processor and memory coupled with the processor. The processor may be configured to transmit, to a network entity, a request for sidelink resources for a reference signal measurement associated with set of multiple reference signals for a set of multiple UEs, receive, from the network entity, an indication of a periodic set of sidelink resources for the reference signal measurement and a time-domain variation associated with the set of multiple reference signals for each UE of the set of multiple UEs, transmit, to each UE of the set of multiple UEs, an indication of the periodic set of sidelink resources for the reference signal measurement and a respective time-domain variation associated with the set of multiple reference signals for each sidelink resource of the periodic set of sidelink resources, and communicate the set of multiple reference signals over the periodic set of sidelink resources according to the time-domain variation associated with the set of multiple reference signals for each UE of the set of multiple UEs.

Another apparatus for wireless communications at a first UE is described. The apparatus may include means for transmitting, to a network entity, a request for sidelink resources for a reference signal measurement associated with a set of multiple reference signals for a set of multiple UEs, means for receiving, from the network entity, an indication of a periodic set of sidelink resources for the reference signal measurement and a time-domain variation associated with the set of multiple reference signals for each UE of the set of multiple UEs, means for transmitting, to each UE of the set of multiple UEs, an indication of the periodic set of sidelink resources for the reference signal measurement and a respective time-domain variation associated with the set of multiple reference signals for each sidelink resource of the periodic set of sidelink resources, and means for communicating the set of multiple reference signals over the periodic set of sidelink resources according to the time-domain variation associated with the set of multiple reference signals for each UE of the set of multiple UEs.

A non-transitory computer-readable medium storing code for wireless communications at a first UE is described. The code may include instructions executable by a processor to transmit, to a network entity, a request for sidelink resources for a reference signal measurement associated with set of multiple reference signals for a set of multiple UEs, receive, from the network entity, an indication of a periodic set of sidelink resources for the reference signal measurement and a time-domain variation associated with the set of multiple reference signals for each UE of the set of multiple UEs, transmit, to each UE of the set of multiple UEs, an indication of the periodic set of sidelink resources for the reference signal measurement and a respective time-domain variation associated with the set of multiple reference signals for each sidelink resource of the periodic set of sidelink resources, and communicate the set of multiple reference signals over the periodic set of sidelink resources according to the time-domain variation associated with the set of multiple reference signals for each UE of the set of multiple UEs.

Some examples of the method, apparatuses, and non-transitory computer-readable medium described herein may further include operations, features, means, or instructions for receiving an associated time-domain offset for each UE of the set of multiple UEs in a first sidelink resource of the periodic set of sidelink resources and determining, based on the time-domain variation, an offset cyclic shift for the reference signal measurement, the communicating the set of multiple reference signals being based on the associated time-domain offset for each UE of the set of multiple UEs and the offset cyclic shift for the reference signal measurement.

Some examples of the method, apparatuses, and non-transitory computer-readable medium described herein may further include operations, features, means, or instructions for receiving an indication of a periodicity for the periodic set of sidelink resources and determining, based on the time-domain variation, a sequence of time-domain offsets corresponding to each sidelink resource of the periodic set of sidelink resources for each UE of the set of multiple UEs, the communicating the set of multiple reference signals being based on the periodicity for the periodic set of sidelink resources and the sequence of time-domain offsets.

Some examples of the method, apparatuses, and non-transitory computer-readable medium described herein may further include operations, features, means, or instructions for transmitting, to each UE of the set of multiple UEs, an indication of a pseudo-random sequence, where the sequence of time-domain offsets may be determined based on the pseudo-random sequence and corresponding UE identifiers for each UE of the set of multiple UEs.

Some examples of the method, apparatuses, and non-transitory computer-readable medium described herein may further include operations, features, means, or instructions for determining a non-repeating hopping pattern across the periodic set of sidelink resources for each UE of the set of multiple UEs, where a UE of the set of multiple UEs may be scheduled to communicate in each transmission time interval index of a set of transmission time interval indexes once over the periodic set of sidelink resources before repeating transmission on any transmission time interval index of the set of transmission time interval indexes.

In some examples of the method, apparatuses, and non-transitory computer-readable medium described herein, the non-repeating hopping pattern may be determined based on a UE identifier, a relay identifier, a source device identifier, a destination device identifier, or any combination thereof.

Some examples of the method, apparatuses, and non-transitory computer-readable medium described herein may further include operations, features, means, or instructions for receiving, from a second UE of the set of multiple UEs, a reference signal resource request for the sidelink resources for the reference signal measurement, where the request for the sidelink resources may be transmitted to the network entity based on receiving the reference signal resource request from the second UE.

Some examples of the method, apparatuses, and non-transitory computer-readable medium described herein may further include operations, features, means, or instructions for broadcasting an indication of the periodic set of sidelink resources including a periodicity for the periodic set of sidelink resources and the time-domain variation associated with the set of multiple reference signals.

Some examples of the method, apparatuses, and non-transitory computer-readable medium described herein may further include operations, features, means, or instructions for transmitting the set of multiple reference signals over the periodic set of sidelink resources according to the time-domain variation associated with the set of multiple reference signals for each UE of the set of multiple UEs.

Some examples of the method, apparatuses, and non-transitory computer-readable medium described herein may further include operations, features, means, or instructions for monitoring for the set of multiple reference signals over the periodic set of sidelink resources according to the time-domain variation associated with the set of multiple reference signals for each UE of the set of multiple UEs.

In some examples of the method, apparatuses, and non-transitory computer-readable medium described herein, the reference signal measurement may be a sidelink channel state information (CSI) reference signal (CSI-RS) measurement, a sidelink positioning reference signal (PRS) measurement, a sounding reference signal (SRS) measurement, or any combination thereof.

A method for wireless communications at a second UE is described. The method may include receiving, from a first UE, an indication of a periodic set of sidelink resources for a reference signal measurement associated with one or more reference signals and a time-domain variation associated with the one or more reference signals and communicating the one or more reference signals over the periodic set of sidelink resources according to the time-domain variation.

An apparatus for wireless communications at a second UE is described. The apparatus may include a processor and memory coupled with the processor. The processor may be configured to receive, from a first UE, an indication of a periodic set of sidelink resources for a reference signal measurement associated with one or more reference signals and a time-domain variation associated with the one or more reference signals and communicate the one or more reference signals over the periodic set of sidelink resources according to the time-domain variation.

Another apparatus for wireless communications at a second UE is described. The apparatus may include means for receiving, from a first UE, an indication of a periodic set of sidelink resources for a reference signal measurement associated with one or more reference signals and a time-domain variation associated with the one or more reference signals and means for communicating the one or more reference signals over the periodic set of sidelink resources according to the time-domain variation.

A non-transitory computer-readable medium storing code for wireless communications at a second UE is described. The code may include instructions executable by a processor to receive, from a first UE, an indication of a periodic set of sidelink resources for a reference signal measurement associated with one or more reference signals and a time-domain variation associated with the one or more reference signals and communicate the one or more reference signals over the periodic set of sidelink resources according to the time-domain variation.

Some examples of the method, apparatuses, and non-transitory computer-readable medium described herein may further include operations, features, means, or instructions for receiving an indication of a time-domain offset for a first sidelink resource of the periodic set of sidelink resources and an offset cyclic shift for the reference signal measurement over the periodic set of sidelink resources, the communicating the one or more reference signals being based on the time-domain offset and the offset cyclic shift for the reference signal measurement.

Some examples of the method, apparatuses, and non-transitory computer-readable medium described herein may further include operations, features, means, or instructions for receiving an indication of a periodicity for the periodic set of sidelink resources and a sequence of time-domain offsets corresponding to each sidelink resource of the periodic set of sidelink resources, the communicating the one or more reference signals being based on the periodicity for the periodic set of sidelink resources and the sequence of time-domain offsets.

Some examples of the method, apparatuses, and non-transitory computer-readable medium described herein may further include operations, features, means, or instructions for receiving an indication of a pseudo-random sequence, where the sequence of time-domain offsets may be determined based on the pseudo-random sequence and a UE identifier for the second UE.

Some examples of the method, apparatuses, and non-transitory computer-readable medium described herein may further include operations, features, means, or instructions for determining a non-repeating hopping pattern across the periodic set of sidelink resources, where the second UE may be scheduled to communicate in each transmission time interval index of a set of transmission time interval indexes once over the periodic set of sidelink resources before repeating transmission on any transmission time interval index of the set of transmission time interval indexes.

In some examples of the method, apparatuses, and non-transitory computer-readable medium described herein, the non-repeating hopping pattern may be determined based on a UE identifier, a relay identifier, a source device identifier, a destination device identifier, or any combination thereof.

Some examples of the method, apparatuses, and non-transitory computer-readable medium described herein may further include operations, features, means, or instructions for transmitting, to the first UE, a reference signal resource request for the periodic set of sidelink resources for the reference signal measurement, where the indication of the periodic set of sidelink resources may be received based on transmitting the reference signal resource request.

Some examples of the method, apparatuses, and non-transitory computer-readable medium described herein may further include operations, features, means, or instructions for monitoring for the one or more reference signals over the periodic set of sidelink resources according to the time-domain variation associated with the one or more reference signals.

Some examples of the method, apparatuses, and non-transitory computer-readable medium described herein may further include operations, features, means, or instructions for transmitting the one or more reference signals over the periodic set of sidelink resources according to the time-domain variation associated with the one or more reference signals.

A method for wireless communications at a network entity is described. The method may include obtaining a first request for sidelink resources for a reference signal measurement associated with one or more reference signals for a first set of multiple UEs and outputting an indication of a periodic set of sidelink resources for the reference signal measurement and a time-domain variation associated with the one or more reference signals for each UE of the first set of multiple UEs.

An apparatus for wireless communications at a network entity is described. The apparatus may include a processor and memory coupled with the processor. The processor may be configured to obtain a first request for sidelink resources for a reference signal measurement associated with one or more reference signals for a first set of multiple UEs and output an indication of a periodic set of sidelink resources for the reference signal measurement and a time-domain variation associated with the one or more reference signals for each UE of the first set of multiple UEs.

Another apparatus for wireless communications at a network entity is described. The apparatus may include means obtaining a first request for sidelink resources for a reference signal measurement associated with one or more reference signals for a first set of multiple UEs and means for outputting an indication of a periodic set of sidelink resources for the reference signal measurement and a time-domain variation associated with the one or more reference signals for each UE of the first set of multiple UEs.

A non-transitory computer-readable medium storing code for wireless communications at a network entity is described. The code may include instructions executable by a processor to obtain a first request for sidelink resources for a reference signal measurement associated with one or more reference signals for a first set of multiple UEs and output an indication of a periodic set of sidelink resources for the reference signal measurement and a time-domain variation associated with the one or more reference signals for each UE of the first set of multiple UEs.

Some examples of the method, apparatuses, and non-transitory computer-readable medium described herein may further include operations, features, means, or instructions for determining the time-domain variation based on an offset cyclic shift for the reference signal measurement and a time-domain offset in a first sidelink resource of the periodic set of sidelink resources for each UE of the first set of multiple UEs and outputting an indication of the offset cyclic shift for the reference signal measurement and the time-domain offset in the first sidelink resource of the periodic set of sidelink resources for each UE of the first set of multiple UEs.

Some examples of the method, apparatuses, and non-transitory computer-readable medium described herein may further include operations, features, means, or instructions for determining the time-domain variation based on a sequence of time-domain offsets corresponding to each sidelink resource of the periodic set of sidelink resources for each UE of the first set of multiple UEs and outputting an indication of the sequence of time-domain offsets and a periodicity for the periodic set of sidelink resources.

Some examples of the method, apparatuses, and non-transitory computer-readable medium described herein may further include operations, features, means, or instructions for outputting an indication of a pseudo-random sequence, where the sequence of time-domain offsets may be determined based on the pseudo-random sequence and corresponding UE identifiers for each UE of the first set of multiple UEs.

Some examples of the method, apparatuses, and non-transitory computer-readable medium described herein may further include operations, features, means, or instructions for determining a non-repeating hopping pattern across the periodic set of sidelink resources for each UE of the first set of multiple UEs, where a UE of the first set of multiple UEs may be scheduled to communicate in each transmission time interval index of a set of transmission time interval indexes of a sidelink resource once over the periodic set of sidelink resources before repeating transmission on any transmission time interval index of the set of transmission time interval indexes.

In some examples of the method, apparatuses, and non-transitory computer-readable medium described herein, the non-repeating hopping pattern may be determined based on a UE identifier, a relay identifier, a source device identifier, a destination device identifier, or any combination thereof.

Some examples of the method, apparatuses, and non-transitory computer-readable medium described herein may further include operations, features, means, or instructions for obtaining a second request from a second UE for a second sidelink resources for a reference signal measurement for a second set of multiple UEs, where the periodic set of sidelink resources for the reference signal measurement and the time-domain variation may be based on the second request and the second set of multiple UEs.

A method for wireless communications at a first UE is described. The method may include transmitting, to a base station, a request for sidelink resources for a reference signal measurement for a set of multiple UEs, receiving, from the base station, an indication of a periodic set of sidelink resources for the reference signal measurement and a time-domain variation associated with the reference signal measurement for each UE of the set of multiple UEs, transmitting, to each UE of the set of multiple UEs, an indication of the periodic set of sidelink resources for the reference signal measurement and a respective time-domain variation associated with the reference signal measurement for each sidelink resource of the periodic set of sidelink resources, and communicating a set of multiple reference signals over the periodic set of sidelink resources according to the time-domain variation associated with the reference signal measurement for each UE of the set of multiple UEs.

An apparatus for wireless communications at a first UE is described. The apparatus may include a processor and memory coupled with the processor. The processor may be configured to transmit, to a base station, a request for sidelink resources for a reference signal measurement for a set of multiple UEs, receive, from the base station, an indication of a periodic set of sidelink resources for the reference signal measurement and a time-domain variation associated with the reference signal measurement for each UE of the set of multiple UEs, transmit, to each UE of the set of multiple UEs, an indication of the periodic set of sidelink resources for the reference signal measurement and a respective time-domain variation associated with the reference signal measurement for each sidelink resource of the periodic set of sidelink resources, and communicate a set of multiple reference signals over the periodic set of sidelink resources according to the time-domain variation associated with the reference signal measurement for each UE of the set of multiple UEs.

Another apparatus for wireless communications at a first UE is described. The apparatus may include means for transmitting, to a base station, a request for sidelink resources for a reference signal measurement for a set of multiple UEs, means for receiving, from the base station, an indication of a periodic set of sidelink resources for the reference signal measurement and a time-domain variation associated with the reference signal measurement for each UE of the set of multiple UEs, means for transmitting, to each UE of the set of multiple UEs, an indication of the periodic set of sidelink resources for the reference signal measurement and a respective time-domain variation associated with the reference signal measurement for each sidelink resource of the periodic set of sidelink resources, and means for communicating a set of multiple reference signals over the periodic set of sidelink resources according to the time-domain variation associated with the reference signal measurement for each UE of the set of multiple UEs.

A non-transitory computer-readable medium storing code for wireless communications at a first UE is described. The code may include instructions executable by a processor to transmit, to a base station, a request for sidelink resources for a reference signal measurement for a set of multiple UEs, receive, from the base station, an indication of a periodic set of sidelink resources for the reference signal measurement and a time-domain variation associated with the reference signal measurement for each UE of the set of multiple UEs, transmit, to each UE of the set of multiple UEs, an indication of the periodic set of sidelink resources for the reference signal measurement and a respective time-domain variation associated with the reference signal measurement for each sidelink resource of the periodic set of sidelink resources, and communicate a set of multiple reference signals over the periodic set of sidelink resources according to the time-domain variation associated with the reference signal measurement for each UE of the set of multiple UEs.

Some examples of the method, apparatuses, and non-transitory computer-readable medium described herein may further include operations, features, means, or instructions for receiving an associated time-domain offset for each UE of the set of multiple UEs in a first sidelink resource of the periodic set of sidelink resources and determining, based on the time-domain variation, an offset cyclic shift for the reference signal measurement, the communicating the set of multiple reference signals being based on the associated time-domain offset for each UE of the set of multiple UEs and the offset cyclic shift for the reference signal measurement.

Some examples of the method, apparatuses, and non-transitory computer-readable medium described herein may further include operations, features, means, or instructions for receiving an indication of a periodicity for the periodic set of sidelink resources and determining, based on the time-domain variation, a sequence of time-domain offsets corresponding to each sidelink resource of the periodic set of sidelink resources for each UE of the set of multiple UEs, the communicating the set of multiple reference signals being based on the periodicity for the periodic set of sidelink resources and the sequence of time-domain offsets.

Some examples of the method, apparatuses, and non-transitory computer-readable medium described herein may further include operations, features, means, or instructions for transmitting, to each UE of the set of multiple UEs, an indication of a pseudo-random sequence, where the sequence of time-domain offsets may be determined based on the pseudo-random sequence and corresponding UE identifiers for each UE of the set of multiple UEs.

Some examples of the method, apparatuses, and non-transitory computer-readable medium described herein may further include operations, features, means, or instructions for determining a non-repeating hopping pattern across the periodic set of sidelink resources for each UE of the set of multiple UEs, where a UE of the set of multiple UEs may be scheduled to communicate in each transmission time interval index over the periodic set of sidelink resources before repeating any transmission time interval index.

In some examples of the method, apparatuses, and non-transitory computer-readable medium described herein, the non-repeating hopping pattern may be determined based on a UE identifier, a relay identifier, a source device identifier, a destination device identifier, or any combination thereof.

Some examples of the method, apparatuses, and non-transitory computer-readable medium described herein may further include operations, features, means, or instructions for receiving, from a second UE of the set of multiple UEs, a reference signal resource request for the sidelink resources for the reference signal measurement, where the request for the sidelink resources may be transmitted to the base station based on receiving the reference signal resource request from the second UE.

Some examples of the method, apparatuses, and non-transitory computer-readable medium described herein may further include operations, features, means, or instructions for broadcasting an indication of the periodic set of sidelink resources including a periodicity for the periodic set of sidelink resources and the time-domain variation associated with the reference signal measurement.

Some examples of the method, apparatuses, and non-transitory computer-readable medium described herein may further include operations, features, means, or instructions for transmitting the set of multiple reference signals over the periodic set of sidelink resources according to the time-domain variation associated with the reference signal measurement for each UE of the set of multiple UEs.

Some examples of the method, apparatuses, and non-transitory computer-readable medium described herein may further include operations, features, means, or instructions for monitoring for the set of multiple reference signals over the periodic set of sidelink resources according to the time-domain variation associated with the reference signal measurement for each UE of the set of multiple UEs.

In some examples of the method, apparatuses, and non-transitory computer-readable medium described herein, the reference signal measurement may be a sidelink CSI-RS measurement, a sidelink PRS measurement, a sidelink SRS measurement, or any combination thereof.

A method for wireless communications at a second UE is described. The method may include receiving, from a first UE, an indication of a periodic set of sidelink resources for a reference signal measurement and a time-domain variation associated with the reference signal measurement and communicating one or more reference signals over the periodic set of sidelink resources according to the time-domain variation.

An apparatus for wireless communications at a second UE is described. The apparatus may include a processor and memory coupled with the processor. The processor may be configured receive, from a first UE, an indication of a periodic set of sidelink resources for a reference signal measurement and a time-domain variation associated with the reference signal measurement and communicate one or more reference signals over the periodic set of sidelink resources according to the time-domain variation.

Another apparatus for wireless communications at a second UE is described. The apparatus may include means for receiving, from a first UE, an indication of a periodic set of sidelink resources for a reference signal measurement and a time-domain variation associated with the reference signal measurement and means for communicating one or more reference signals over the periodic set of sidelink resources according to the time-domain variation.

A non-transitory computer-readable medium storing code for wireless communications at a second UE is described. The code may include instructions executable by a processor to receive, from a first UE, an indication of a periodic set of sidelink resources for a reference signal measurement and a time-domain variation associated with the reference signal measurement and communicate one or more reference signals over the periodic set of sidelink resources according to the time-domain variation.

Some examples of the method, apparatuses, and non-transitory computer-readable medium described herein may further include operations, features, means, or instructions for receiving an indication of a time-domain offset for a first sidelink resource of the periodic set of sidelink resources and an offset cyclic shift for the reference signal measurement over the periodic set of sidelink resources, the communicating the one or more reference signals being based on the time-domain offset and the offset cyclic shift for the reference signal measurement.

Some examples of the method, apparatuses, and non-transitory computer-readable medium described herein may further include operations, features, means, or instructions for receiving an indication of a periodicity for the periodic set of sidelink resources and a sequence of time-domain offsets corresponding to each sidelink resource of the periodic set of sidelink resources, the communicating the one or more reference signals being based on the periodicity for the periodic set of sidelink resources and the sequence of time-domain offsets.

Some examples of the method, apparatuses, and non-transitory computer-readable medium described herein may further include operations, features, means, or instructions for receiving an indication of a pseudo-random sequence, where the sequence of time-domain offsets may be determined based on the pseudo-random sequence and a UE identifier for the second UE.

Some examples of the method, apparatuses, and non-transitory computer-readable medium described herein may further include operations, features, means, or instructions for determining a non-repeating hopping pattern across the periodic set of sidelink resources, where the second UE may be scheduled to communicate in each transmission time interval index over the periodic set of sidelink resources before repeating any transmission time interval index.

In some examples of the method, apparatuses, and non-transitory computer-readable medium described herein, the non-repeating hopping pattern may be determined based on a UE identifier, a relay identifier, a source device identifier, a destination device identifier, or any combination thereof.

Some examples of the method, apparatuses, and non-transitory computer-readable medium described herein may further include operations, features, means, or instructions for transmitting, to the first UE, a reference signal resource request for the periodic set of sidelink resources for the reference signal measurement, where the indication of the periodic set of sidelink resources may be received based on transmitting the reference signal resource request.

Some examples of the method, apparatuses, and non-transitory computer-readable medium described herein may further include operations, features, means, or instructions for monitoring for the one or more reference signals over the periodic set of sidelink resources according to the time-domain variation associated with the reference signal measurement.

Some examples of the method, apparatuses, and non-transitory computer-readable medium described herein may further include operations, features, means, or instructions for transmitting the one or more reference signals over the periodic set of sidelink resources according to the time-domain variation associated with the reference signal measurement.

A method for wireless communications at a base station is described. The method may include receiving, from a first UE, a first request for sidelink resources for a reference signal measurement for a first set of multiple UEs and transmitting, to the first UE, an indication of a periodic set of sidelink resources for the reference signal measurement and a time-domain variation associated with the reference signal measurement for each UE of the first set of multiple UEs.

An apparatus for wireless communications at a base station is described. The apparatus may include a processor and memory coupled with the processor. The processor may be configured to receive, from a first UE, a first request for sidelink resources for a reference signal measurement for a first set of multiple UEs and transmit, to the first UE, an indication of a periodic set of sidelink resources for the reference signal measurement and a time-domain variation associated with the reference signal measurement for each UE of the first set of multiple UEs.

Another apparatus for wireless communications at a base station is described. The apparatus may include means for receiving, from a first UE, a first request for sidelink resources for a reference signal measurement for a first set of multiple UEs and means for transmitting, to the first UE, an indication of a periodic set of sidelink resources for the reference signal measurement and a time-domain variation associated with the reference signal measurement for each UE of the first set of multiple UEs.

A non-transitory computer-readable medium storing code for wireless communications at a base station is described. The code may include instructions executable by a processor to receive, from a first UE, a first request for sidelink resources for a reference signal measurement for a first set of multiple UEs and transmit, to the first UE, an indication of a periodic set of sidelink resources for the reference signal measurement and a time-domain variation associated with the reference signal measurement for each UE of the first set of multiple UEs.

Some examples of the method, apparatuses, and non-transitory computer-readable medium described herein may further include operations, features, means, or instructions for determining the time-domain variation based on an offset cyclic shift for the reference signal measurement and a time-domain offset in a first sidelink resource of the periodic set of sidelink resources for each UE of the first set of multiple UEs and transmitting an indication of the offset cyclic shift for the reference signal measurement and the time-domain offset in the first sidelink resource of the periodic set of sidelink resources for each UE of the first set of multiple UEs.

Some examples of the method, apparatuses, and non-transitory computer-readable medium described herein may further include operations, features, means, or instructions for determining the time-domain variation based on a sequence of time-domain offsets corresponding to each sidelink resource of the periodic set of sidelink resources for each UE of the first set of multiple UEs and transmitting an indication of the sequence of time-domain offsets and a periodicity for the periodic set of sidelink resources.

Some examples of the method, apparatuses, and non-transitory computer-readable medium described herein may further include operations, features, means, or instructions for transmitting, to the first UE, an indication of a pseudo-random sequence, where the sequence of time-domain offsets may be determined based on the pseudo-random sequence and corresponding UE identifiers for each UE of the first set of multiple UEs.

Some examples of the method, apparatuses, and non-transitory computer-readable medium described herein may further include operations, features, means, or instructions for determining a non-repeating hopping pattern across the periodic set of sidelink resources for each UE of the first set of multiple UEs, where a UE of the first set of multiple UEs may be scheduled to communicate in each transmission time interval index of a sidelink resource over the periodic set of sidelink resources before repeating any transmission time interval index.

In some examples of the method, apparatuses, and non-transitory computer-readable medium described herein, the non-repeating hopping pattern may be determined based on a UE identifier, a relay identifier, a source device identifier, a destination device identifier, or any combination thereof.

Some examples of the method, apparatuses, and non-transitory computer-readable medium described herein may further include operations, features, means, or instructions for receiving a second request from a second UE for a second sidelink resources for the reference signal measurement for a second set of multiple UEs, where the periodic set of sidelink resources for the reference signal measurement and the time-domain variation may be based on the second request and the second set of multiple UEs.

### BRIEF DESCRIPTION OF THE DRAWINGS

FIG. 1 illustrates an example of a wireless communications system that supports time-domain variation for sidelink reference signal transmission in accordance with aspects of the present disclosure.

FIG. 2 illustrates an example of a wireless communications system that supports time-domain variation for sidelink reference signal transmission in accordance with aspects of the present disclosure.

FIG. 3 illustrates an example of a cyclic shift time-domain variation scheme that supports time-domain variation for sidelink reference signal transmission in accordance with aspects of the present disclosure.

FIG. 4 illustrates an example of a pseudo-random sequence-based time-domain variation scheme that supports time-domain variation for sidelink reference signal transmission in accordance with aspects of the present disclosure.

FIG. 5 illustrates an example of a hopping pattern time-domain variation scheme that supports time-domain variation for sidelink reference signal transmission in accordance with aspects of the present disclosure.

FIG. 6 illustrates an example of a wireless communications system that supports time-domain variation for sidelink reference signal transmission in accordance with aspects of the present disclosure.

FIG. 7 illustrates an example of a process flow that supports time-domain variation for sidelink reference signal transmission in accordance with aspects of the present disclosure.

FIGS. 8 and 9 show block diagrams of devices that support time-domain variation for sidelink reference signal transmission in accordance with aspects of the present disclosure.

FIG. 10 shows a block diagram of a communications manager that supports time-domain variation for sidelink reference signal transmission in accordance with aspects of the present disclosure.

FIG. 11 shows a diagram of a system including a device that supports time-domain variation for sidelink reference signal transmission in accordance with aspects of the present disclosure.

FIGS. 12 and 13 show block diagrams of devices that support time-domain variation for sidelink reference signal transmission in accordance with aspects of the present disclosure.

FIG. 14 shows a block diagram of a communications manager that supports time-domain variation for sidelink reference signal transmission in accordance with aspects of the present disclosure.

FIG. 15 shows a diagram of a system including a device that supports time-domain variation for sidelink reference signal transmission in accordance with aspects of the present disclosure.

FIGS. 16 through 22 show flowcharts illustrating methods that support time-domain variation for sidelink reference signal transmission in accordance with aspects of the present disclosure.

### DETAILED DESCRIPTION

Some wireless communications systems may use sidelink communication between devices such as UEs. UEs may communicate data and control signaling on sidelink channels, such as a physical sidelink shared channel (PSSCH) and a physical sidelink control channel (PSCCH). In some examples, UEs may determine CSI by transmitting and measuring reference signals (e.g., CSI-RS) on a sidelink channel. A UE receiving the CSI-RS may transmit a CSI report to the transmitting UE. In some cases, the transmitting UE may adjust a configuration to provide higher quality sidelink communications based on the CSI report. In some cases, the transmitting UE may trigger a CSI report via sidelink control information (SCI) and include CSI-RS in a PSSCH associated with the SCI. The receiving UE may measure the CSI-RS and send a CSI report to the transmitting UE. The CSI report may include, for example, a rank indicator and a channel quality indicator (CQI). UEs may similarly communicate other reference signals, such as phase-tracking reference signals (PT-RS) on the sidelink channel.

In some cases, a UE may operate as a relay UE between a network entity and a group of other UEs. The relay UE and the other UEs in the group (e.g., referred to as remote UEs) may perform CSI measurements and use the CSI to adjust a configuration of the sidelink channels between the relay UE and the remote UEs. In some cases, a relay UE may transmit reference signals to a remote UE, or the remote UE may transmit reference signals to the relay UE. In some examples, the remote UEs may be assigned reference signal resources to acquire sidelink CSI by the relay UE or by a network entity. In some cases, the relay UE may assign the reference signal resources for different remote UEs with different offsets within a transmission time interval (TTI) to avoid collisions between remote UE transmissions on the assigned resources. However, assigning static offsets for the remote UEs may result in CSI for some of the remote UEs to be aged or outdated by the time the CSI procedure as described above is complete. For example, if a first remote UE is assigned to measure a CSI-RS in an early symbol of a slot carrying CSI-RS for multiple remote UEs, the first remote UE may detect different channel conditions than a second remote UE that is assigned to measure a CSI-RS in a later symbol of the slot carrying CSI-RS, as the channel conditions may have changed between the earlier symbol land the later symbol.

Techniques described herein support using a time-domain variation for sidelink CSI resources. These techniques may support assigning orthogonal resources for sidelink communications so that remote UEs can transmit reference signals with limited or no collisions between remote UEs while preventing CSI for the remote UEs from being outdated. A remote UE may be configured with a time-domain resource for a reference signal measurement procedure, and the configuration may include a periodicity, an offset, and a time-domain variation for the offset across measurement instances. That is, across measurement instances, the offset for the reference signal measurement procedure may vary in a manner specified by the time-domain variation. While some aspects of the present disclosure refer to techniques using CSI-RS, these techniques may additionally, or alternatively, be implemented for other types of reference signals, such as PRS, PT-RS, and SRS, among others.

In some cases, the time-domain variation may be based on a sequence of different offsets for each measurement occasion, and the remote UE may increment an index of the sequence after each measurement occasion. In some cases, the time-domain variation may be based on a pseudo-random sequence of offsets for a measurement occasion. For example, an ordering of the offsets for the measurement occasion may be determined based on a pseudo-random sequence. In some cases, the time-domain variation may be based on a cyclic shift of an initial offset across instances. For example, an offset for a remote UE may shift (e.g., increment symbol period indexes) across different measurement occasions, changing to a first symbol period of a reference signal resource in a next measurement occasion after the offset for the remote UE is in a last symbol period of the reference signal resource. In some examples, the time-domain variation may be based on a non-repeating hopping scheme for the offset across the instances. The non-repeating hopping scheme may involve a pattern for the value of the offset after each measurement occasion which ensures that the value of the offset is not repeated until each value for the offset in the scheme is used once. By decreasing collisions and outdated CSI information, these techniques may increase wireless spectrum utilization and transmission reliability of remote UEs and network entities in communication with them. Furthermore, these techniques may decrease the number of retransmissions needed due to the decreased collisions and outdated transmissions, reducing the power consumption at remote UEs.

Aspects of the disclosure are initially described in the context of wireless communications systems. Aspects of the disclosure are further illustrated by and described with reference to apparatus diagrams, system diagrams, and flowcharts that relate to time-domain variation for sidelink reference signal transmission.

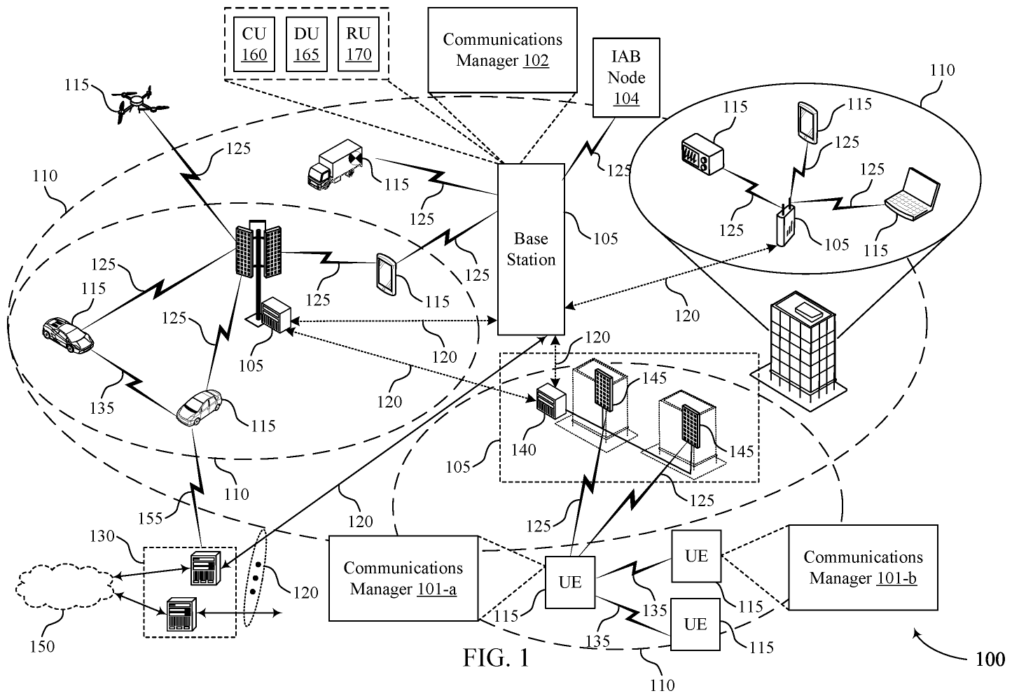

FIG. 1 illustrates an example of a wireless communications system 100 that supports time-domain variation for sidelink reference signal transmission in accordance with aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time-domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time-domain) of the wireless communications system 100 and may be referred to as a TTI. In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105). For example, a positioning server or positioning network entity may manage or handle positioning techniques or positioning information for one or more devices, such as base stations 105 or UEs 115, in the wireless communications system 100. In some cases, a network entity 140 may be an example of a base station 105.

The wireless communications system 100 may operate using one or more frequency bands, which may be in the range of 300 MHz to 300 gigahertz (GHz). The region from 300 MHz to 3 GHz is sometimes referred to as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Some sidelink communications systems may support one or more modes of operation for allocating sidelink resources. In some cases, a base station 105 may allocate resources for sidelink communications between UEs 115, which may be referred to as mode 1. In some cases, UEs 115 may autonomously select sidelink resources, which may be referred to as mode 2. Signaling on a sidelink may be the same for both modes. For example, a receiving device may operate the same for both modes. Wireless communications systems described herein may support mode 1 or mode 2, or both modes, for sidelink communications. In some cases, some sidelink communications systems may support HARQ-based retransmission schemes.

CSI reporting may be supported in sidelink communications systems. For example, CSI reporting may be supported for unicast communications. A UE 115 may trigger a CSI report explicitly in SCI and include CSI-RS in the associated PSSCH. The receiving UE may report CSI via MAC CE. CSI may include bits for a rank indicator (e.g., one bit for the rank indicator) and bits for CQI (e.g., four bits for CQI). PT-RS may be supported for some systems. For example, PT-RS may be supported in Frequency Range 2. In some examples, a number of PT-RS ports may be the same as a number of demodulation reference signal (DMRS) ports.

In some cases, a UE 115 may operate as a relay UE 115 between a base station 105 and a group of UEs 115. The relay UE 115 and the UEs 115 in the group (e.g., remote UEs 115) may perform CSI measurements and use the CSI to adjust a configuration of the sidelink channels between the relay UE 115 and the remote UEs 115. In some cases, a relay UE 115 may transmit the reference signals to a remote UE 115, or the remote UE 115 may transmit the reference signals to the relay UE 115. In some cases, the relay UE 115, or a base station 105, may assign reference signal resources to the remote UEs 115 to acquire sidelink CSI. In some cases, the relay UE 115 may assign the reference signal resources with different offsets within a TTI for different remote UEs 115 to avoid collisions between the assigned resources. However, assigning static offsets for the remote UEs 115 may result in CSI for some of the remote UEs 115 to be aged or outdated by the time the CSI procedure is complete. For example, if a first remote UE 115 is assigned for a CSI measurement procedure at a first slot within a CSI resource, the channel conditions for the first remote UE 115 may have already changed after the CSI measurement procedure for the other remote UEs 115 is completed.

Techniques described herein support using a time-domain variation for sidelink CSI resources. These techniques may support assigning orthogonal resources for sidelink communications so that remote UEs 115 can transmit reference signals with limited collisions while preventing CSI for the remote UEs 115 from being outdated. A remote UE 115 may be configured with a time-domain resource for a reference signal measurement procedure, and the configuration may include a periodicity, an offset, and a time-domain variation for the offset across measurement instances. In some cases, the time-domain variation may be indicated to the remote UE 115 with a set of offsets, and the remote UE 115 may increment an index of the set across different instances of the reference signal resource. In some cases, the time-domain variation may be based on generating a pseudo-random sequence of offsets for each measurement occasion, using a UE identifier to obtain an offset from the pseudo-random sequence. In some cases, the time-domain variation may be based on a cyclic shift of an initial offset across reference signal resource instances. In some examples, the time-domain variation may be based on a non-repeating hopping scheme across the instances. For example, according to the non-repeating hopping scheme, a remote UE 115 may perform a CSI measurement on each TTI index of the a measurement resource before repeating a first-used TTI index.

In various examples, a communication manager 101 may be included in a device to support resolving a scheduling conflict for overlapping sidelink transmissions. For example, a UE 115 may include a communications manager 101-a or a communications manager 101-b, or both. For example, a UE 115 which is an example of a relay UE 115 may include a communications manager 101-a, and a UE 115 which may be an example of a remote UE 115 may include a communications manager 101-b. A base station 105 may include a communications manager 102.

In some examples, a communication manager 101-a may transmit, to a base station 105, a request for sidelink resources for a reference signal measurement for a set of multiple UEs 115. The communication manager 101-a may receive, from the base station 105, an indication of a periodic set of sidelink resources for the reference signal measurement and a time-domain variation associated with the reference signal measurement or a reference signal from a set of multiple reference signals for each UE 115 of the set of multiple UEs 115. The communication manager 101-a may transmit, to each UE 115 of the set of multiple UEs 115, an indication of the periodic set of sidelink resources for the reference signal measurement and a respective time-domain variation associated with the reference signal measurement for each sidelink resource of the periodic set of sidelink resources. The communication manager 101-a may communicate the set of multiple reference signals over the periodic set of sidelink resources according to the time-domain variation associated with the reference signal measurement for each UE 115 of the set of multiple UEs 115.

In some examples, a communication manager 101-b may receive, from a first UE 115, an indication of a periodic set of sidelink resources for a reference signal measurement and a time-domain variation associated with the reference signal measurement. The communication manager 101-b may communicate one or more reference signals over the periodic set of sidelink resources according to the time-domain variation.

In some examples, a communication manager 102 may receive, from a first UE 115, a first request for sidelink resources for a reference signal measurement for a first set of multiple UEs 115. The communication manager 102 may transmit, to the first UE 115, an indication of a periodic set of sidelink resources for the reference signal measurement and a time-domain variation associated with the reference signal measurement for each UE 115 of the first set of multiple UEs 115.

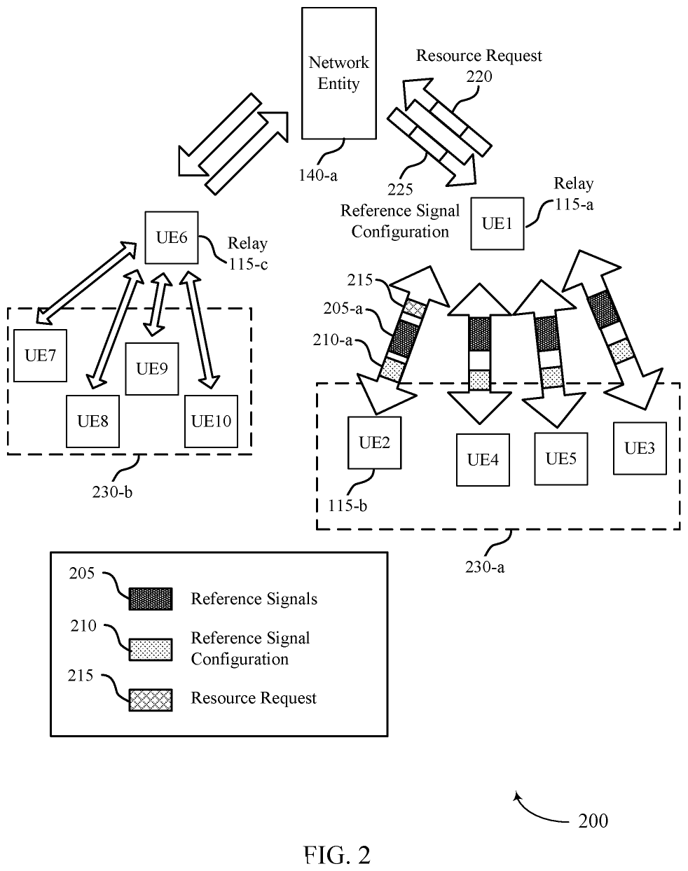

FIG. 2 illustrates an example of a wireless communications system 200 that supports time-domain variation for sidelink reference signal transmission in accordance with aspects of the present disclosure.

The wireless communications system 200 may include network entity 140-a and multiple UEs 115. Network entity 140-a may be an example of a network entity 140 or a base station 105 as described with reference to FIG. 1. Each of the UEs 115 may be examples of a UE 115 as described with reference to FIG. 1. The wireless communications system 200 may support sidelink communications between UEs 115. For example, UE 115-a and UE 115-b may communicate on a sidelink channel. UE 115-a may have a connection to network entity 140-a, such as a Uu connection, which may provide wireless communications services such as LTE, NR, or both. In some cases, a UE 115 such as UE 115-b or UE 115-c may a have link (e.g., a Uu connection) established with network entity 140-a.

The wireless communications system 200 may support relay communications between a relay UE 115 and one or more remote UEs 115. For example, UE 115-a may operate as a relay UE 115 for a group 230 of one or more remote UEs 115. In an example, UE 115-a may operate as a relay UE 115 between network entity 140-a and group 230-a of remote UEs 115 including UE 115-b and UE 115-c. In some cases, the wireless communications system 200 may include multiple relay UEs 115. For example, UE 115-c may also operate as a relay UE 115 for group 230-b of remote UEs 115.

UE 115-a and group 230-a of the remote UEs 115 may perform sidelink CSI measurements. For example, a remote UE 115 in group 230-a may transmit reference signals 205 (e.g., CSI-RS) to UE 115-a on a sidelink channel, and UE 115-a may measure the reference signals 205 to determine CSI for the sidelink channel. UE 115-a may adjust configurations for the sidelink channel with the remote UE 115 based on the CSI. In some cases, UE 115-a may send a CSI report to the remote UE 115. Additionally, or alternatively, the remote UE 115 may adjust a configuration based on the CSI. UE 115-a may trigger one or more remote UEs 115 in group 230-a for the sidelink CSI measurement. In some examples, UE 115-a may implement techniques described herein to transmit the reference signals 205 to the one or more remote UEs 115, and the one or more remote UEs 115 may perform the measurements.

UE 115-a may schedule group 230-a of the remote UEs 115 to perform sidelink CSI measurements on a sidelink CSI-RS resource. The sidelink CSI-RS resource may have a periodicity, and each instance of the sidelink CSI-RS resource may include one or more TTIs, such as symbols or slots. For example, the sidelink CSI-RS resource may span one slot in the time-domain with a periodicity of 10 ms. Each remote UE 115 of group 230-a may transmit CSI-RS on one or more symbols of the slot for the CSI-RS measurement. In some cases, each remote UE 115 may have an offset with the slot to transmit CSI-RS. For example, UE2 (e.g., UE 115-b) may transmit CSI-RS on symbols 2 through 4, UE3 may transmit CSI-RS on symbols 5 and 6, UE4 may transmit CSI-RS on symbols 7 through 12, and UE5 may transmit CSI-RS on symbol 13. In this example, UE2 may have an offset of 1 symbol period, UE3 may have an offset of 4 symbol periods, UE4 may have an offset of 6 symbol periods, and UE5 may have an offset of 12 symbol periods. In some cases, symbol 0 may be used for other signaling (e.g., SCI or PSSCH), and symbol 14 may be a gap symbol period. In some examples, the offset may be in reference to a first TTI of a reference signal resource which is used for reference signal transmission. For example, in the above example, UE2 may have an offset of 0 symbol periods if the first symbol period of the slot is not used for reference signal transmission.

The wireless communications system 200 may support techniques for using a time-domain variation for sidelink CSI resources. These techniques may support assigning orthogonal resources for sidelink communications so that a UE 115 can transmit reference signals on the sidelink with limited collisions while preventing CSI for the UE 115 from being outdated. These techniques may be implemented for one or more sidelink reference signal measurements, such as sidelink CSI-RS measurements, sidelink PT-RS measurements, SRS measurements, sidelink PRS measurements or any combination thereof.

For example, UE 115-b may receive a reference signal configuration 210-a for a time-domain resource for a reference signal measurement procedure. In some cases, the reference signal configuration 210-a may include a periodicity of a reference signal resource, an offset, a time-domain variation for the offset across instances of the reference signal resource, or any combination thereof. The time-domain variation may provide a scheme to change an offset for each remote UE 115 across different instances of the reference signal resource. This may ensure that CSI for any remote UE 115 is not consistently outdated across instances. For example, if UE 115-b were configured with a static offset to transmit first of group 230-a, the channel conditions for UE 115-b may have already changed after each remote UE 115 of group 230-a has finished transmitting, or the CSI for UE 115-b would be outdated. Instead, the techniques described herein provide fairness for sidelink CSI measurements for a group 230 of remote UEs 115.

In a first example, each remote UE 115 of group 230-a may be configured with a sequence of offsets and a periodicity. The periodicity may be common for each remote UE 115, but the sequence of offsets may be configured individually for each of the remote UEs 115. For example, reference signal configuration 210-a may include a periodicity and a sequence of offsets for UE 115-b. In the Xth instance, UE 115-b may use the Xth slot offset to transmit or receive the reference signals 205-a. In an example, the periodicity may be 10 ms, and the sequence of offsets for UE 115-b may be {0, 2, 6, 9, 5}. At a first instance, UE 115-b may use a first offset from the sequence, or 0. UE 115-b may then use a next offset from the sequence (e.g., an offset of 2) for a next instance of the reference signal resource (e.g., 10 ms later). The sequences for each of the remote UEs 115 of group 230-a may be configured such that the reference signal transmissions are orthogonal, preventing collisions between the remote UEs 115 on the reference signal resources.

In a second example, the time-domain variation may be based on a pseudo-random sequence. For example, each UE 115 may be configured with a function to generate a pseudo-random sequence based on an input, and a UE 115 may select an offset from the pseudo-random sequence based on a UE identifier. For example, reference signal configuration 210 may include a pseudo-random index and a periodicity for the reference signal resource. For a first reference signal resource instance, UE 115-b may generate a first sequence based on the pseudo-random index to obtain a sequence. UE 115-b may then use a UE identifier for UE 115-b to obtain an offset from the sequence for the first instance of the reference signal resource. The remote UEs 115 may increment the pseudo-random index for a second instance of the reference signal resource. If N is 4 symbols, the function may generate a sequence such as {3, 1, 0, 2}. UE 115-b may be considered a first remote UE 115 in group 230-a, so UE 115-b may use the first value in the sequence, 3, for an offset. UE3, UE4, and UE5 may be assigned the other indexes in the sequence corresponding to respective UE identifiers. In some cases, the function may generate a sequence which provides offsets such that reference signal communication by the remote UEs 115 is orthogonal in each instance of the reference signal resource.

In a third example, the time-domain variation may be based on a cyclic shift of offsets across instances of the reference signal resource. For example, each reference signal configuration 210 may include a periodicity for the reference signal resource and a set of offsets for the remote UEs 115 in group 230-a. At a first instance of a reference signal resource, UE 115-b may use a first offset from the sequence. For a second instance, UE 115-b may use a next or second offset from the set of offsets. If UE 115-b is using a last offset from the sequence, UE 115-b may use a first offset from the sequence for a subsequent instance of the reference signal resource. In some cases, UE 115-b may identify a first offset to use from the set of offsets based on an identifier for UE 115-b. In some examples, an ordering for a set of offsets in a reference signal configuration 210 may be configured according to a remote UE 115 receiving the configuration.

In a fourth example, the time-domain variation may be based on a non-repeating hopping scheme across the instances. For example, an instance of the reference signal resource may span a slot. UE 115-b may communicate the reference signals 205-a of each symbol index in a slot across multiple instances of the reference signal resource before repeating a symbol index. For example, with a periodicity of K, UE 115-b may transmit or receive CSI-RS in all K slots or symbols (e.g., instances) before repeating any of the slots. In some cases, the hopping pattern may be based on UE identifiers. For example, remote UEs 115 may have different hopping patterns according to their different UE identifiers. In some cases, the hopping pattern may be based on a destination identifier, a relay identifier, a source identifier, or a combination thereof. In some cases, the hopping pattern may be based on the combination thereof and time (e.g., reference signal resource instance or time resources). In some cases, the hopping pattern may be indicated by a reference signal configuration 210. In some examples, the hopping pattern, or a function to determine the hopping pattern, may be configured at the remote UEs 115.

In some cases, a remote UE 115 may request time-domain reference signal resources from a relay UE 115. For example, UE 115-b may send a resource request 215 to UE 115-a. In some examples, the resource request 215 may be a request for reference signal resources for the remote UEs 115 in group 230-a. In some other examples, the resource request 215 may be a request for UE 115-b, and UE 115-a may determine that UE 115-b is included in group 230-a. In some examples, UE 115-a may receive a resource request 215 from multiple UEs 115 in group 230-a. In some cases, UE 115-a may send a resource request 220 to network entity 140-a based on receiving the resource request 215 from UE 115-a. Network entity 140-a may send a reference signal configuration 225 to UE 115-a. The reference signal configuration 225 may include an indication of the reference signal resources, a periodicity of the reference signal resource, offsets for the remote UEs 115 in group 230-a, an indication of a time-domain variation scheme, or any combination thereof. In some cases, the reference signal configuration 225 may include a time-domain variation scheme based on any one or more of the above examples.

In some cases, network entity 140-a may configure a reference signal resource for multiple groups 230 of remote UEs 115. For example, the remote UEs 115 in group 230-a and group 230-b may be configured to communicate the reference signals 205 on a reference signal resource. In some cases, the periodicity, offsets, time-domain variations, or any combination thereof, may be configured based on both of the groups 230. For example, network entity 140-a may assign orthogonal resources for group 230-b and group 230-a. The remote UEs 115 of group 230-a and group 230-b may communicate reference signals with limited, or no, collisions without resulting in outdated CSI information by implementing one or more of the time-domain variation schemes. In an example, a time-domain variation may be based on the remote UEs 115 in both of the groups 230, such that a sequence of offsets indicated by a reference signal configuration 210 may prevent reference signal collisions between remote UEs 115 of group 230-a or group 230-b while increasing fairness for CSI measurements for the remote UEs 115 in both groups. Network entity 140-a may similarly send a reference signal configuration 225 to UE 115-c, which may operate as a relay UE 115 for group 230-b.

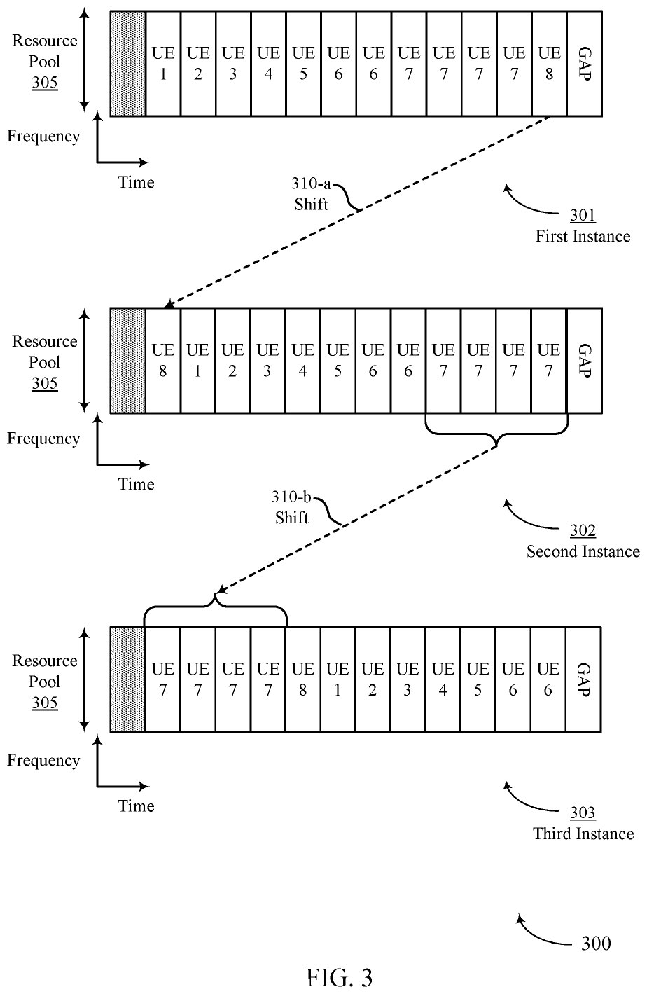

FIG. 3 illustrates an example of a cyclic shift time-domain variation scheme 300 that supports time-domain variation for sidelink reference signal transmission in accordance with aspects of the present disclosure.

The cyclic shift time-domain variation scheme 300 may be an example of a time-domain variation scheme described herein. For example, a set of remote UEs 115 may be configured with a periodic reference signal resource of a resource pool 305 on a sidelink channel for a sidelink reference signal measurement. The set of remote UEs 115 may be configured with a set of offsets, including an initial offset for a first instance of the reference signal resource. Some UEs 115 may be configured with more time-domain resources than other UEs 115. For example, UE7 in this example may be configured for four TTIs in the reference signal resource, while UE1 may be configured with one TTI in the reference signal resource.

To prevent CSI for one remote UE 115 from being consistently outdated, the remote UEs 115 may be configured with a time-domain variation to adjust the offset within the reference signal resource over instances of the reference signal resource. For the cyclic shift time-domain-variation scheme 300, the time-domain variation may be a cyclic shift which may be applied to offsets for the set of remote UEs 115. The time-domain variation may be indicated to a transmitting UE 115 or a receiving UE 115 (e.g., one or more remote UEs 115), or both. For example, to the transmitting UE 115, the time-domain variation may correspond to a collection or a set of offsets, each offset used at different instances for reference signals transmitted to different receiving UEs 115. For a receiving UE 115 such as a remote UE 115, the time-domain variation may correspond to different offsets for a reference signal measurement across different instances. For example, The receiving UE 115 may identify the time-domain variation as different offsets, or as a change or variation to an offset, for a reference signal measurement across different instances of a reference signal resource. In some examples, the time-domain variation may be associated, to a transmitting UE, with the reference signal, and the time-domain variation may be associated, to a receiving UE, with the reference signal measurement for the reference signal.

The cyclic shift time-domain variation scheme 300 may show examples of three instances of a reference signal resource, including a first instance 301, a second instance 302, and a third instance 303. Remote UEs 115 in the set of remote UEs 115 may change offsets within the reference signal resource across the instances according to a cyclic shift. The example of the cyclic shift time-domain-variation scheme 300 shows eight UEs 115 configured for a reference signal resource. In some cases, the eight UEs 115 may belong to one group of UEs 115, which may communicate with a base station 105 or a network entity 140 via a relay UE 115. In some other examples, the eight UEs 115 may belong to different groups (e.g., two groups of four UEs 115), and each of the different groups may communicate with a base station 105 or a network entity 140 via a relay UE 115.

For the first instance 301, the UEs 115 may communicate reference signals according to an initial offset within the reference signal resource. For example, UE1 may have an offset of 0, and UE2 may have an offset of 1. In some cases, UE1 may receive an indication of a set of offsets for the set of UEs 115 and an indication of an initial offset for UE1. In some examples, the set of UEs 115 may receive an indication of a number of TTIs assigned for each UE 115 on using the reference signal resource.

After the first instance 301, UE1 may cyclically shift the offsets within the set of offsets. Example, after performing the cyclic shift, one TTI may be shifted out, and the new offset for UE1 for the second instance 302 may be 1. At the second instance 302, UE1 may use the new offset to communicate a reference signal. For example, at the second instance 302, UE1 may communicate a reference signal according to an offset of 1. For the first instance 301, UE8 may have an offset of 11. After performing shift 310-a, UE8 may have an offset of 0 for the second instance 302.

After the second instance 302, the UEs 115 may perform another cyclic shift. For example, UE7 may communicate with an offset of 7. After performing shift 310-b, UE7 may communicate with an offset of 0 for the third instance 303. Similarly, after the second instance 302, four TTIs may be shifted out, and UE8 may communicate a reference signal with an offset of 4 for the third instance 303, and UE1 may communicate with an offset of 5.

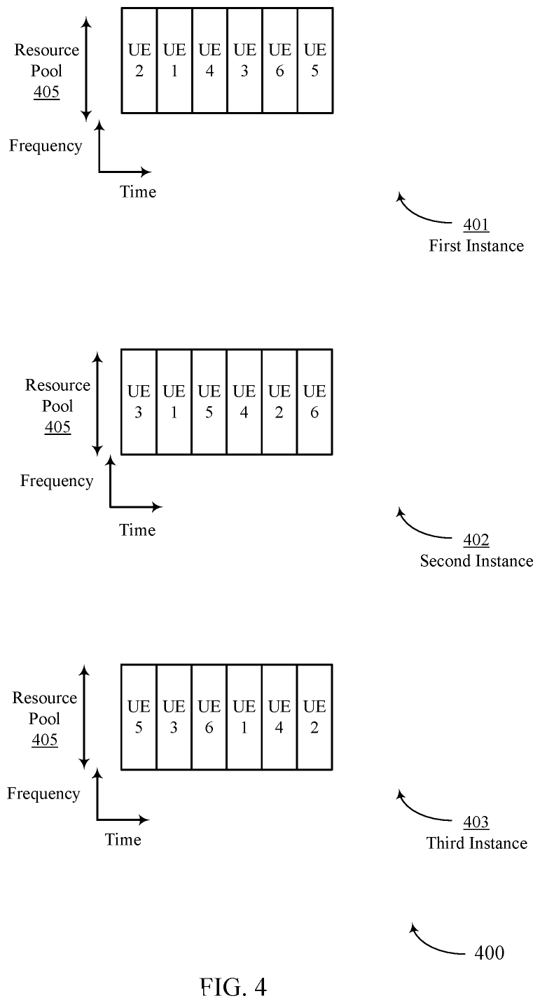

FIG. 4 illustrates an example of a pseudo-random sequence-based time-domain variation scheme 400 that supports time-domain variation for sidelink reference signal transmission in accordance with aspects of the present disclosure.

The pseudo-random sequence-based time-domain variation scheme 400 may be an example of a time-domain variation scheme described herein. A relay UE 115 may have sidelink channels established with a set of remote UE 115. In some cases, the relay UE 115 may be referred to as UE0, and the set of remote UEs may include UE1 through UE6. The relay UE 115 and the set of remote UEs 115 may perform reference signal measurement procedures on reference signal resources of the sidelink channel. For example, the UEs 115 may be configured with a periodic reference signal resource of a resource pool 405 on a sidelink channel for a sidelink reference signal measurement. The pseudo-random sequence-based time-domain variation scheme 400 may enable techniques to prevent collisions on the reference signal resources.

For example, a relay UE 115 and a set of remote UEs 115 may be configured with a function to generate a pseudo-random sequence based on an input. In some cases, the relay UE 115 and the remote UEs 115 may each receive a configuration indicating a reference signal resource allocation, a periodicity for the reference signal resource, and the input for the function. The relay UE 115 and the set of remote UEs 115 may each generate a pseudo-random sequence using the function and the input to the function. A remote UE 115 may use an offset within an instance of the reference signal resource instance in the pseudo-random sequence according to a UE identifier.

For example, at a first reference signal resource instance 401, the UEs 115 may generate a first sequence based on the pseudo-random index to obtain a sequence. In some cases, each UE 115 may generate the same sequence, which may be indexed by corresponding UE identifiers to avoid collisions on the reference signal resources. The relay UE 115 may identify each slot offset for the remote UEs 115 according to the respective identifiers for the remote UEs 115, and each remote UE 115 may identify its own offset using the identifier for the remote UE 115. For example, UEs 1 through 6 may generate the sequence {1, 0, 3, 2, 5, 4} based on the input. UE1 may use the first index of the sequence as an offset (e.g., an offset of 1), UE2 may use the second index of the sequence as an offset (e.g., an offset of 0), and the other UEs 115 may similarly use offsets indicated by indexes of the sequence according to respective UE identifiers.

The UEs 115 may increment the value for the input for the second reference signal resource instance 402. The UEs 115 may generate a second sequence based on the incremented value. For example, UEs 1 through 6 may generate the sequence {1, 4, 0, 3, 2, 5} based on the incremented value. UE1 may use the first index of the sequence as an offset (e.g., an offset of 1), UE2 may use the second index of the sequence as an offset (e.g., an offset of 4), and the other UEs 115 may similarly use offsets indicated by indexes of the sequence according to respective UE identifiers. For example, the relay UE 115 and the first remote UE 115 (e.g., UE1) may communicate a reference signal in the reference signal resource using an offset of 1.

The UEs 115 may again increment the value for the input for the third reference signal resource instance 403. The UEs 115 may generate a third sequence based on the incremented value. For example, UEs 1 through 6 may generate the sequence {3, 5, 1, 4, 0, 2} based on the incremented value. UE1 may use the first index of the sequence as an offset (e.g., an offset of 3), UE2 may use the second index of the sequence as an offset (e.g., an offset of 5), and the other UEs 115 may similarly use offsets indicated by indexes of the sequence according to respective UE identifiers.

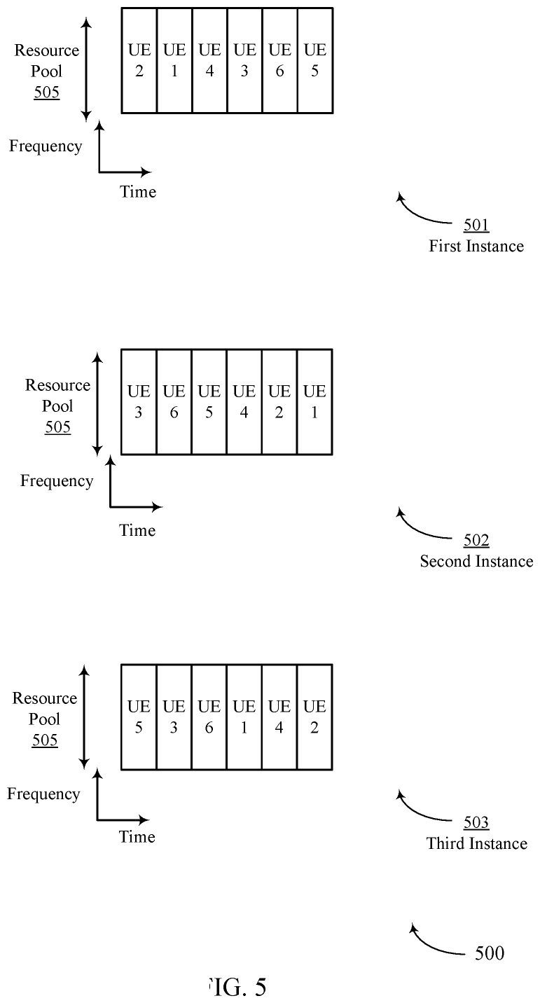

FIG. 5 illustrates an example of a hopping pattern time-domain variation scheme 500 that supports time-domain variation for sidelink reference signal transmission in accordance with aspects of the present disclosure.

The hopping pattern time-domain variation scheme 500 may be an example of a time-domain variation scheme described herein. A relay UE 115 may have sidelink channels established with a set of remote UE 115. In some cases, the relay UE 115 may be referred to as UE0, and the set of remote UEs may include UE1 through UE6. The relay UE 115 and the set of remote UEs 115 may perform reference signal measurement procedures on reference signal resources of the sidelink channel. For example, the UEs 115 may be configured with a periodic reference signal resource of a resource pool 505 on a sidelink channel for a sidelink reference signal measurement. The hopping pattern time-domain variation scheme 500 may enable techniques to prevent collisions on the reference signal resources.

For example, a relay UE 115 and a set of remote UEs 115 may apply a time-domain hopping pattern to determine offsets for different reference signal resource instances. Using the time-domain hopping pattern, a remote UE 115 may be configured to visit each TTI index over reference signal resource instances before revisiting a first TTI index. For example, the remote UE 115 may visit, or communicate using, each hopping symbol before using a first-used hopping symbol. The time-domain hopping pattern may be indicated to the relay UE 115 and the remote UEs 115 via configuration signaling, or the time-domain hopping pattern may be determined based on a function at the relay UE 115 UEs 115. In some cases, the hopping pattern may be based on UE identifiers. For example, the hopping pattern may vary for different UE identifiers, destination identifiers, source identifiers, remote UE identifiers, relay UE identifiers, or any combination thereof.

In an example, a first remote UE 115 (e.g., UE1) may identify a first offset for a first reference signal resource instance 401. For example, UE1 may communicate a reference signal in TTI 2 of the first reference signal resource instance 501. UE1 may communicate using the other five TTIs before communicating another reference signal in TTI 2. For example, at a second reference signal resource instance 502, UE1 may use TTI 6. At a third reference signal resource instance 503, UE1 may use TTI 4. UE1 may use the remaining TTIs (e.g., TTI 1, 3, and 5) before reusing TTI 2. In some cases, the other UEs 115 (e.g., UEs 2 through UE 6) may each use offsets according to respective hopping patterns to avoid reusing a TTI before using each other TTI of the reference signal resource. A relay UE 115 may identify the hopping patterns for the remote UEs 115 and communicate reference signals with the remote UEs 115 according to the hopping patterns.

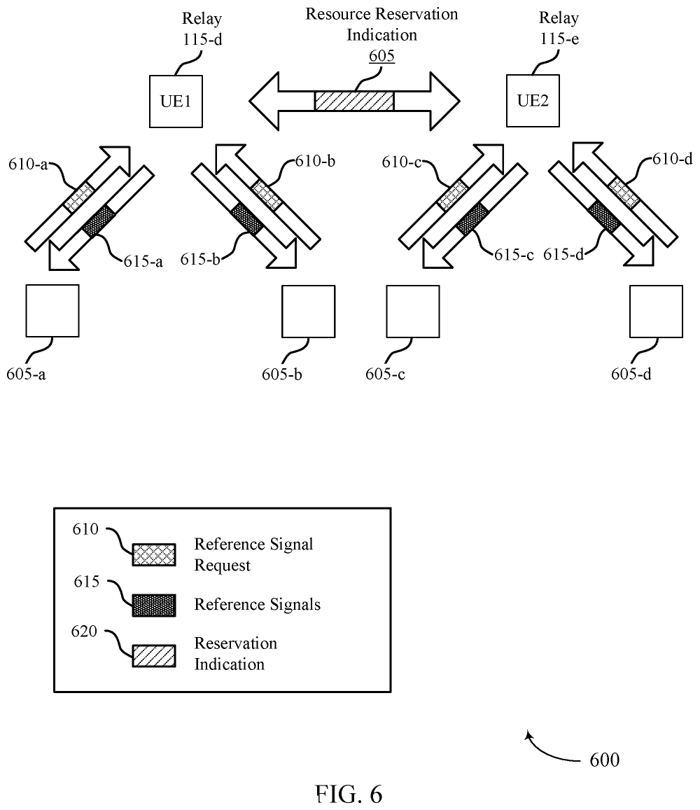

FIG. 6 illustrates an example of a wireless communications system 600 that supports time-domain variation for sidelink reference signal transmission in accordance with aspects of the present disclosure.

The wireless communications system 600 may include UE 115-d and UE 115-e and multiple devices 605. A device 605, such as device 605-a, device 605-b, device 605-c, or device 605-c, may be an example of a UE 115, such as a remote UE 115, a smart device, or another type of wireless device. UE 115-e and UE 115-d may each have a sidelink established with one or more devices 605. For example, UE 115-d may communicate with device 605-a and device 605-b on sidelink channels, and UE 115-e may communicate with device 605-c and device 605-d on sidelink channels. In some cases, UE 115-d and UE 115-e may be in communication with a base station 105 or a network entity 140. For example, UE 115-d and UE 115-e may be examples of relay UEs 115 for remote UEs 115. In some cases, device 605-a and device 605-b may be included in a first group served by UE 115-d, and device 605-c and device 605-d may be included in a second group served by UE 115-e.

The wireless communications system 600 may support techniques for assigning resources of a periodic reference signal resource to the devices 605 using a time-domain variation. For example, a device 605 may transmit a reference signal request 610 to a relay UE 115. Device 605-a may transmit reference signal request 610-a to UE 115-d, and device 605-b may transmit reference signal request 610-b to UE 115-d. Similarly, device 605-c may transmit reference signal request 610-c to UE 115-e, and device 605-d may transmit reference signal request 610-d to UE 115-e. In some examples, one device 605 of a group may send a reference signal request 610 for the group. Additionally, or alternatively, the reference signal resources may be configured for devices 605 which request the reference signals. In some cases, a relay UE 115 may request reference signal resources from a base station 105 or a network entity 140 based on receiving a reference signal request 610. In some other examples, a relay UE 115 may autonomously assign the reference signal resources from a configured resource pool.

In some cases, a first relay UE 115 may broadcast or groupcast a reservation indication 620 of reference signal resources. The reservation indication 620 may include a periodicity, offsets, and a time-domain variation for the reserved reference signal resource within a resource pool. In some cases, the reservation indication 620 may be a reservation request for the reference signal resources. Based on the reservation indication 620, neighboring relay UEs 115 may identify which resources are occupied by the first relay UE 115. For example, UE 115-d may broadcast or groupcast resource reservation information for a reference signal resource configured for device 605-a and device 605-b. In some cases, device 605-a and device 605-b may receive configurations for the reference signal resource via the reservation indication 620. Device 605-a and device 605-b may communicate reference signals 615 (e.g., reference signals 615-a and reference signals 615-b) according to respective reference signal resource configurations with UE 115-d, and device 605-c and device 605-d may communicate reference signals 615 (e.g., reference signals 615-c and reference signals 615-d) according to respective reference signal resource configurations with UE 115-e.

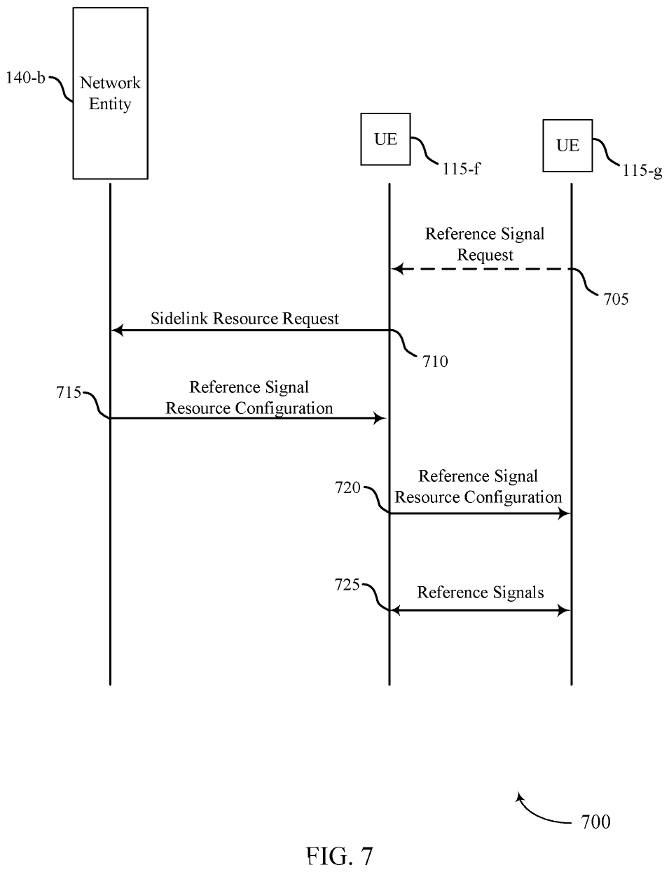

FIG. 7 illustrates an example of a process flow 700 that supports time-domain variation for sidelink reference signal transmission in accordance with aspects of the present disclosure.

The process flow 700 may be implemented by network entity 140-b, UE 115-f, UE 115-g, or any combination thereof. Network entity 140-b may be an example of a network entity 140 or a base station 105 described with reference to FIG. 1. UE 115-f and UE 115-g may each be an example of a UE 115 described with reference to FIG. 1. In some cases, UE 115-f may be an example of a relay UE 115, and UE 115-g may be an example of a remote UE 115. UE 115-g may be one remote UE 115 of a group of remote UEs 115. UE 115-f may operate as a relay UE 115 between network entity 140-b and the group of remote UEs 115.

The process flow 700 may describe techniques to assign a periodic reference signal resource for a group of UEs 115. For example, a relay UE 115, such as UE 115—Each UE 115 of the group may be configured with an offset of the periodic reference signal resource and a time-domain variation to change the offset cover different instances of the periodic reference signal resource. The reference signal may be a CSI-RS, PT-RS, PRS, SRS, or any combination thereof.

In some cases, at 705, UE 115-g may transmit, to UE 115-f, a reference signal resource request for a periodic set of sidelink resources for a reference signal measurement. For example, UE 115-g may request time-domain CSI-RS resources from UE 115-f. In some cases, UE 115-f may receive reference signal resource requests from multiple UEs 115. At 710, UE 115-f may transmit, to network entity 140-b, a request for sidelink resources for the reference signal measurement for a set of multiple UEs 115. The set of multiple UEs 115 may include UE 115-g and may, in some cases, be referred to as a group of UEs 115.

Network entity 140-b may obtain a first request for sidelink resources for the reference signal measurement for the set of multiple UEs 115. For example, network entity 140-b may receive the first request from UE 115-f. At 715, network entity 140-b may output an indication of a periodic set of sidelink resources for the reference signal measurement and a time-domain variation associated with the reference signal measurement for each UE 115 of the set of multiple UEs 115. For example, network entity 140-b may transmit the indication to UE 115-f.

In some cases, network entity 140-b may obtain a second request for sidelink resources for the reference signal measurement for a second set of multiple UEs 115. For example, network entity 140-b may receive the second request from a second UE 115. In some cases, the second UE 115 may be a neighboring relay to UE 115-f, and groups of remote UEs 115 served by the second UE 115 and UE 115-f could experience reference signal resource collisions. Therefore, in some cases, the periodic set of sidelink resources and the time-domain variation associated may also be based on the second request and the second set of multiple UEs 115. For example, network entity 140-b may configure the sidelink reference signal resources, offsets, and time-domain variations for the offsets to avoid collisions between UEs 115 of a same group and between UEs 115 of different groups.

UE 115-f may receive, from network entity 140-b, the indication of the periodic set of sidelink resources for the reference signal measurement and the time-domain variation associated with the reference signal measurement for each UE 115 of the set of multiple UEs 115. At 720, UE 115-f may transmit, to each UE 115 of the set of multiple UEs 115, an indication of the periodic set of sidelink resources for the reference signal measurement and a respective time-domain variation associated with the reference signal measurement for each sidelink resource of the periodic set of sidelink resources. In some cases, UE 115-f may indicate a periodicity for the periodic set of sidelink resources to each UE 115 of the set of multiple UEs 115. For example, UE 115-g may receive an indication of a periodic set of sidelink resources for the reference signal measurement and a time-domain variation associated with the reference signal measurement.

The time-domain variation may adjust an offset within a reference signal resource across different instances. For example, UE 115-g may use a first offset of ‘0’ within a first instance of a reference signal resource. UE 115-g may determine a second offset for a second instance of the reference signal resource based on the time-domain variation. For example, UE 115-g may use an offset of ‘1’ within the second instance of the reference signal resource.

In some cases, UE 115-g may receive an associated time-domain offset for each UE 115 of the set of multiple UEs 115. UE 115-g may determine, based on the time-domain variation, an offset cyclic shift for the reference signal measurement. For example, a second offset for a second instance may be based on a cyclic shift of the time-domain offset for each UE 115 of the set of multiple UEs 115.

In some cases, UE 115-g may receive an indication of a periodicity of the periodic set of sidelink resources and a sequence of time-domain offsets corresponding to each sidelink resource of the periodic set of sidelink resources. In some cases, the sequence of time-domain offsets for each UE 115 of the set of multiple UEs 115 may be configured to avoid collisions at each instance of the reference signal resource.

In some cases, UE 115-g may receive an indication of a pseudo-random sequence, where the sequence of time-domain offsets are determined based on the pseudo-random sequence an a UE identifier for UE 115-g. In some cases, UE 115-g may be configured with a function which may generate the pseudo-random sequence based on an input value. UE 115-g, and each UE 115 of the set of multiple UEs 115, may receive the same input value from UE 115-f and generate a pseudo-random sequence. UE 115-g may use its UE identifier to index the pseudo-random sequence and obtain an offset for a sidelink resource. UE 115-g may increment the input value to obtain a second offset value for a subsequent instance of the sidelink reference signal resource.

In some examples, UE 115-g may determine a non-repeating hopping pattern across the periodic set of sidelink resources, where UE 115-g is scheduled to communicate in each TTI index over the periodic set of sidelink resources before repeating any TTI index. For example, if the reference signal resource spans a slot, and UE 115-g first communicates a reference signal in symbol period 1 of the slot, UE 115-g may communicate a reference signal in each other symbol period index (e.g., symbol periods 0 and 2 through 13) before repeating symbol period 1. In some cases, the non-repeating hopping pattern may be indicated by UE 115-f, or a function to determine the non-repeating hopping pattern may be configured at UE 115-g.

At 725, UE 115-f and UE 115-g may communicate one or more reference signals over the periodic set of sidelink resources according to the time-domain variation. In some cases, UE 115-f may transmit the reference signals, and UE 115-g may measure the reference signals. In some cases, UE 115-g may transmit the reference signals, and UE 115-f may measure the reference signals.

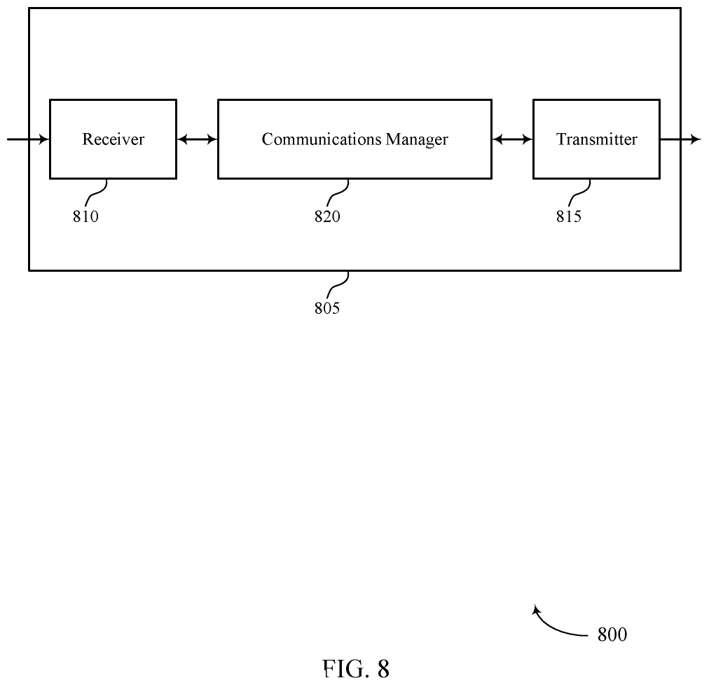

FIG. 8 shows a block diagram 800 of a device 805 that supports time-domain variation for sidelink reference signal transmission in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to time-domain variation for sidelink reference signal transmission). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to time-domain variation for sidelink reference signal transmission). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of time-domain variation for sidelink reference signal transmission as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a first UE in accordance with examples as disclosed herein. For example, the communications manager 820 may be configured as or otherwise support a means for transmitting, to a base station or a network entity, a request for sidelink resources for a reference signal measurement for a set of multiple UEs. The communications manager 820 may be configured as or otherwise support a means for receiving, from the base station or the network entity, an indication of a periodic set of sidelink resources for the reference signal measurement associated with a plurality of reference signals and a time-domain variation associated with the plurality of reference signals or the reference signal measurement for each UE of the set of multiple UEs. The communications manager 820 may be configured as or otherwise support a means for transmitting, to each UE of the set of multiple UEs, an indication of the periodic set of sidelink resources for the reference signal measurement associated with a plurality of reference signals and a respective time-domain variation associated with the plurality of reference signals or the reference signal measurement for each sidelink resource of the periodic set of sidelink resources. The communications manager 820 may be configured as or otherwise support a means for communicating the set of multiple reference signals over the periodic set of sidelink resources according to the time-domain variation associated with the plurality of reference signals or the reference signal measurement for each UE of the set of multiple UEs.

Additionally or alternatively, the communications manager 820 may support wireless communications at a second UE in accordance with examples as disclosed herein. For example, the communications manager 820 may be configured as or otherwise support a means for receiving, from a first UE, an indication of a periodic set of sidelink resources for a reference signal measurement associated with one or more reference signals and a time-domain variation associated with the one or more reference signals or the reference signal measurement. The communications manager 820 may be configured as or otherwise support a means for communicating the one or more reference signals over the periodic set of sidelink resources according to the time-domain variation.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for improving fairness for CSI reporting for a group of remote UEs 115 while preventing collisions on reference signal resources. For example, these techniques may be implemented to apply some variation to offsets in a reference signal resource for a reference signal procedure for the group of UEs 115, such that one UE 115 does not, for example, consistently perform a first CSI measurement procedure of the group of UEs 115. For example, consistently performing CSI measurement procedure at the start of the reference signal resource may result in that CSI measurement procedure being outdated (e.g., as the channel conditions may have already changed) after the rest of the UEs 115 in the group have performed the CSI measurement procedure later in the time-domain on the reference signal resource.

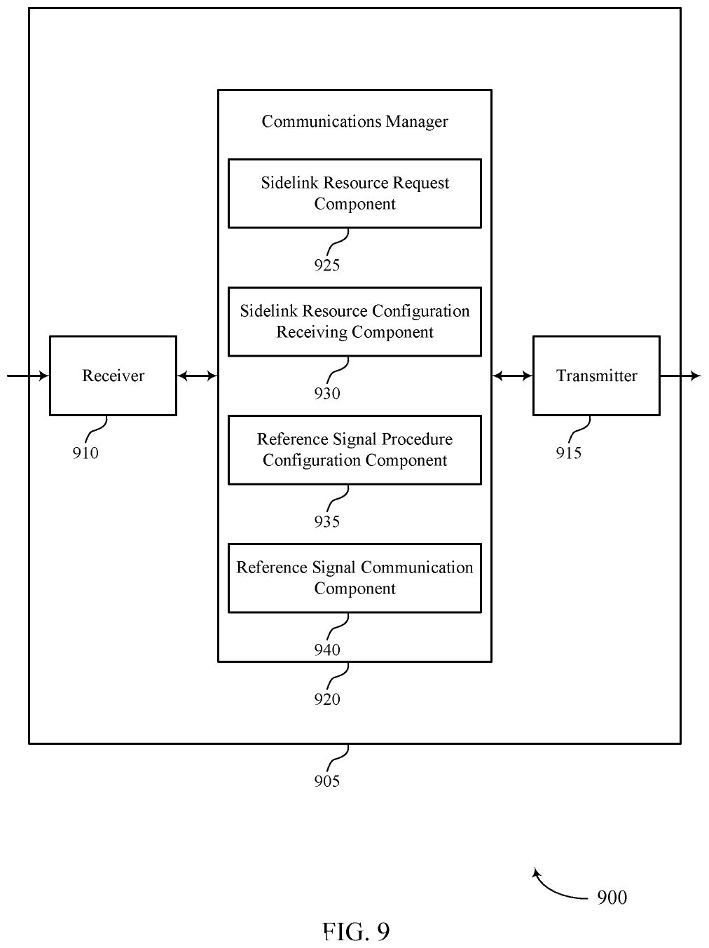

FIG. 9 shows a block diagram 900 of a device 905 that supports time-domain variation for sidelink reference signal transmission in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to time-domain variation for sidelink reference signal transmission). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to time-domain variation for sidelink reference signal transmission). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of time-domain variation for sidelink reference signal transmission as described herein. For example, the communications manager 920 may include a sidelink resource request component 925, a sidelink resource configuration receiving component 930, a reference signal procedure configuration component 935, a reference signal communication component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a first UE in accordance with examples as disclosed herein. The sidelink resource request component 925 may be configured as or otherwise support a means for transmitting, to a base station or a network entity, a request for sidelink resources for a reference signal measurement for a set of multiple UEs. The sidelink resource configuration receiving component 930 may be configured as or otherwise support a means for receiving, from the base station or the network entity, an indication of a periodic set of sidelink resources for the reference signal measurement associated with a set of multiple reference signals and a time-domain variation associated with the set of multiple reference signals or the reference signal measurement for each UE of the set of multiple UEs. The reference signal procedure configuration component 935 may be configured as or otherwise support a means for transmitting, to each UE of the set of multiple UEs, an indication of the periodic set of sidelink resources for the reference signal measurement associated with the set of multiple reference signals and a respective time-domain variation associated with the set of multiple reference signals or the reference signal measurement for each sidelink resource of the periodic set of sidelink resources. The reference signal communication component 940 may be configured as or otherwise support a means for communicating the set of multiple reference signals over the periodic set of sidelink resources according to the time-domain variation associated with the set of multiple reference signals or the reference signal measurement for each UE of the set of multiple UEs.

Additionally or alternatively, the communications manager 920 may support wireless communications at a second UE in accordance with examples as disclosed herein. The reference signal procedure configuration component 935 may be configured as or otherwise support a means for receiving, from a first UE, an indication of a periodic set of sidelink resources for a reference signal measurement associated with a one or more reference signals and a time-domain variation associated with the one or more reference signals or the reference signal measurement. The reference signal communication component 940 may be configured as or otherwise support a means for communicating the one or more reference signals over the periodic set of sidelink resources according to the time-domain variation.

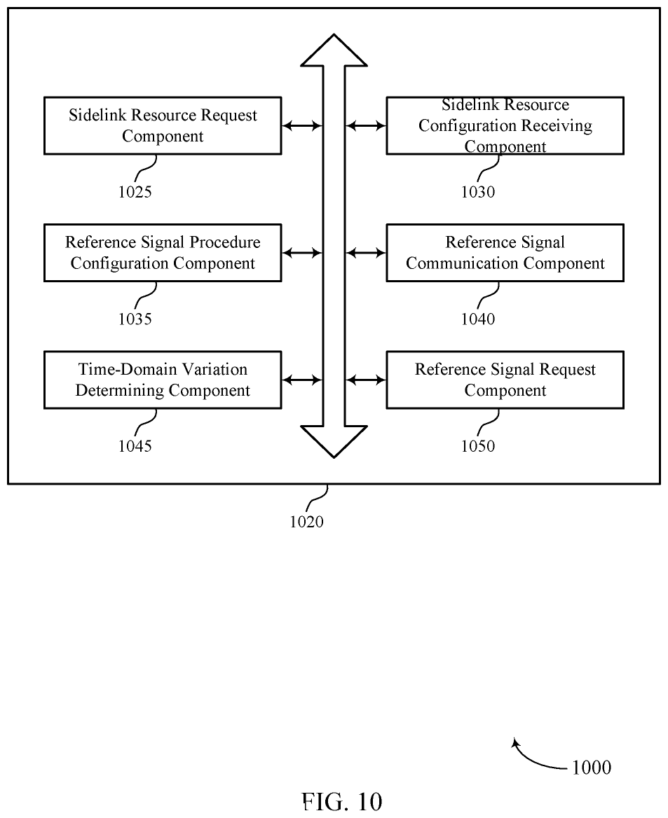

FIG. 10 shows a block diagram 1000 of a communications manager 1020 that supports time-domain variation for sidelink reference signal transmission in accordance with aspects of the present disclosure. The communications manager 1020 may be an example of aspects of a communications manager 820, a communications manager 920, or both, as described herein. The communications manager 1020, or various components thereof, may be an example of means for performing various aspects of time-domain variation for sidelink reference signal transmission as described herein. For example, the communications manager 1020 may include a sidelink resource request component 1025, a sidelink resource configuration receiving component 1030, a reference signal procedure configuration component 1035, a reference signal communication component 1040, a time-domain variation determining component 1045, a reference signal request component 1050, or any combination thereof. Each of these components may communicate, directly or indirectly, with one another (e.g., via one or more buses).

The communications manager 1020 may support wireless communications at a first UE in accordance with examples as disclosed herein. The sidelink resource request component 1025 may be configured as or otherwise support a means for transmitting, to a base station or a network entity, a request for sidelink resources for a reference signal measurement for a set of multiple UEs. The sidelink resource configuration receiving component 1030 may be configured as or otherwise support a means for receiving, from the base station the network entity, an indication of a periodic set of sidelink resources for the reference signal measurement associated with a set of multiple reference signals and a time-domain variation associated with the set of multiple reference signals or the reference signal measurement for each UE of the set of multiple UEs. The reference signal procedure configuration component 1035 may be configured as or otherwise support a means for transmitting, to each UE of the set of multiple UEs, an indication of the periodic set of sidelink resources for the reference signal measurement associated with the set of multiple reference signals and a respective time-domain variation associated with the set of multiple reference signals or the reference signal measurement for each sidelink resource of the periodic set of sidelink resources. The reference signal communication component 1040 may be configured as or otherwise support a means for communicating the set of multiple reference signals over the periodic set of sidelink resources according to the time-domain variation associated with the set of multiple reference signals or the reference signal measurement for each UE of the set of multiple UEs.

In some examples, the sidelink resource configuration receiving component 1030 may be configured as or otherwise support a means for receiving an associated time-domain offset for each UE of the set of multiple UEs in a first sidelink resource of the periodic set of sidelink resources. In some examples, the time-domain variation determining component 1045 may be configured as or otherwise support a means for determining, based on the time-domain variation, an offset cyclic shift for the reference signal measurement, the communicating the set of multiple reference signals being based on the associated time-domain offset for each UE of the set of multiple UEs and the offset cyclic shift for the reference signal measurement.

In some examples, the sidelink resource configuration receiving component 1030 may be configured as or otherwise support a means for receiving an indication of a periodicity for the periodic set of sidelink resources. In some examples, the time-domain variation determining component 1045 may be configured as or otherwise support a means for determining, based on the time-domain variation, a sequence of time-domain offsets corresponding to each sidelink resource of the periodic set of sidelink resources for each UE of the set of multiple UEs, the communicating the set of multiple reference signals being based on the periodicity for the periodic set of sidelink resources and the sequence of time-domain offsets.

In some examples, the reference signal procedure configuration component 1035 may be configured as or otherwise support a means for transmitting, to each UE of the set of multiple UEs, an indication of a pseudo-random sequence, where the sequence of time-domain offsets are determined based on the pseudo-random sequence and corresponding UE identifiers for each UE of the set of multiple UEs.

In some examples, the time-domain variation determining component 1045 may be configured as or otherwise support a means for determining a non-repeating hopping pattern across the periodic set of sidelink resources for each UE of the set of multiple UEs, where a UE of the set of multiple UEs is scheduled to communicate in each transmission time interval index of a plurality of transmission time interval indexes once over the periodic set of sidelink resources before repeating transmission on any transmission time interval index of the plurality of transmission time interval indexes.

In some examples, the non-repeating hopping pattern is determined based on a UE identifier, a relay identifier, a source device identifier, a destination device identifier, or any combination thereof.

In some examples, the reference signal request component 1050 may be configured as or otherwise support a means for receiving, from a second UE of the set of multiple UEs, a reference signal resource request for the sidelink resources for the reference signal measurement, where the request for the sidelink resources is transmitted to the base station or the network entity based on receiving the reference signal resource request from the second UE.

In some examples, the reference signal procedure configuration component 1035 may be configured as or otherwise support a means for broadcasting an indication of the periodic set of sidelink resources including a periodicity for the periodic set of sidelink resources and the time-domain variation associated with the one or more reference signals or the reference signal measurement.

In some examples, the reference signal communication component 1040 may be configured as or otherwise support a means for transmitting the set of multiple reference signals over the periodic set of sidelink resources according to the time-domain variation associated with the one or more reference signals or the reference signal measurement for each UE of the set of multiple UEs.

In some examples, the reference signal communication component 1040 may be configured as or otherwise support a means for monitoring for the set of multiple reference signals over the periodic set of sidelink resources according to the time-domain variation associated with the one or more reference signals or the reference signal measurement for each UE of the set of multiple UEs.

In some examples, the reference signal measurement is a sidelink CSI-RS measurement, a sidelink PRS measurement, an SRS measurement, or any combination thereof.

Additionally or alternatively, the communications manager 1020 may support wireless communications at a second UE in accordance with examples as disclosed herein. In some examples, the reference signal procedure configuration component 1035 may be configured as or otherwise support a means for receiving, from a first UE, an indication of a periodic set of sidelink resources for a reference signal measurement associated with one or more reference signals and a time-domain variation associated with the one or more reference signals or the reference signal measurement. In some examples, the reference signal communication component 1040 may be configured as or otherwise support a means for communicating the one or more reference signals over the periodic set of sidelink resources according to the time-domain variation.

In some examples, the reference signal procedure configuration component 1035 may be configured as or otherwise support a means for receiving an indication of a time-domain offset for a first sidelink resource of the periodic set of sidelink resources and an offset cyclic shift for the reference signal measurement over the periodic set of sidelink resources, the communicating the one or more reference signals being based on the time-domain offset and the offset cyclic shift for the reference signal measurement.

In some examples, the reference signal procedure configuration component 1035 may be configured as or otherwise support a means for receiving an indication of a periodicity for the periodic set of sidelink resources and a sequence of time-domain offsets corresponding to each sidelink resource of the periodic set of sidelink resources, the communicating the one or more reference signals being based on the periodicity for the periodic set of sidelink resources and the sequence of time-domain offsets.

In some examples, the reference signal procedure configuration component 1035 may be configured as or otherwise support a means for receiving an indication of a pseudo-random sequence, where the sequence of time-domain offsets are determined based on the pseudo-random sequence and a UE identifier for the second UE.

In some examples, the time-domain variation determining component 1045 may be configured as or otherwise support a means for determining a non-repeating hopping pattern across the periodic set of sidelink resources, where the second UE is scheduled to communicate in each transmission time interval index of a plurality of transmission time interval indexes once over the periodic set of sidelink resources before repeating transmission on any transmission time interval index of the plurality of transmission time interval indexes.

In some examples, the non-repeating hopping pattern is determined based on a UE identifier, a relay identifier, a source device identifier, a destination device identifier, or any combination thereof.

In some examples, the reference signal request component 1050 may be configured as or otherwise support a means for transmitting, to the first UE, a reference signal resource request for the periodic set of sidelink resources for the reference signal measurement, where the indication of the periodic set of sidelink resources is received based on transmitting the reference signal resource request.

In some examples, the reference signal communication component 1040 may be configured as or otherwise support a means for monitoring for the one or more reference signals over the periodic set of sidelink resources according to the time-domain variation associated with the one or more reference signals or the reference signal measurement.

In some examples, the reference signal communication component 1040 may be configured as or otherwise support a means for transmitting the one or more reference signals over the periodic set of sidelink resources according to the time-domain variation associated with the one or more reference signals or the reference signal measurement.

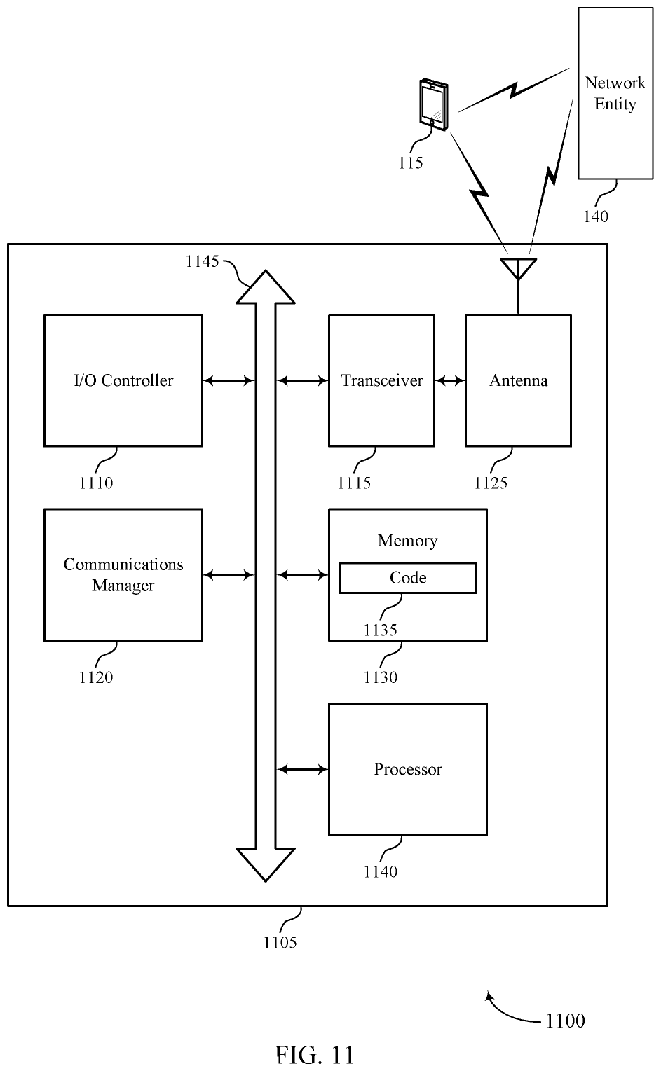

FIG. 11 shows a diagram of a system 1100 including a device 1105 that supports time-domain variation for sidelink reference signal transmission in accordance with aspects of the present disclosure. The device 1105 may be an example of or include the components of a device 805, a device 905, or a UE 115 as described herein. The device 1105 may communicate wirelessly with one or more network entities 140, base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting time-domain variation for sidelink reference signal transmission). For example, the device 1105 or a component of the device 1105 may include a processor 1140 and memory 1130 coupled with the processor 1140, the processor 1140 and memory 1130 configured to perform various functions described herein.

The communications manager 1120 may support wireless communications at a first UE in accordance with examples as disclosed herein. For example, the communications manager 1120 may be configured as or otherwise support a means for transmitting, to a base station or a network entity, a request for sidelink resources for a reference signal measurement for a set of multiple UEs. The communications manager 1120 may be configured as or otherwise support a means for receiving, from the base station or the network entity, an indication of a periodic set of sidelink resources for the reference signal measurement associated with a set of multiple reference signals and a time-domain variation associated with the set of multiple reference signals or the reference signal measurement for each UE of the set of multiple UEs. The communications manager 1120 may be configured as or otherwise support a means for transmitting, to each UE of the set of multiple UEs, an indication of the periodic set of sidelink resources for the reference signal measurement associated with a set of multiple reference signals and a respective time-domain variation associated with the set of multiple reference signals or the reference signal measurement for each sidelink resource of the periodic set of sidelink resources. The communications manager 1120 may be configured as or otherwise support a means for communicating the set of multiple reference signals over the periodic set of sidelink resources according to the time-domain variation associated with the set of multiple reference signals or the reference signal measurement for each UE of the set of multiple UEs.

Additionally or alternatively, the communications manager 1120 may support wireless communications at a second UE in accordance with examples as disclosed herein. For example, the communications manager 1120 may be configured as or otherwise support a means for receiving, from a first UE, an indication of a periodic set of sidelink resources for a reference signal measurement associated with one or more reference signals and a time-domain variation associated with the one or more reference signals or the reference signal measurement. The communications manager 1120 may be configured as or otherwise support a means for communicating one or more reference signals over the periodic set of sidelink resources according to the time-domain variation.

By including or configuring the communications manager 1120 in accordance with examples as described herein, the device 1105 may support techniques for improving reference signal measurement timeliness and efficiency while preventing collisions on reference signal resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of time-domain variation for sidelink reference signal transmission as described herein, or the processor 1140 and the memory 1130 may be otherwise configured to perform or support such operations.

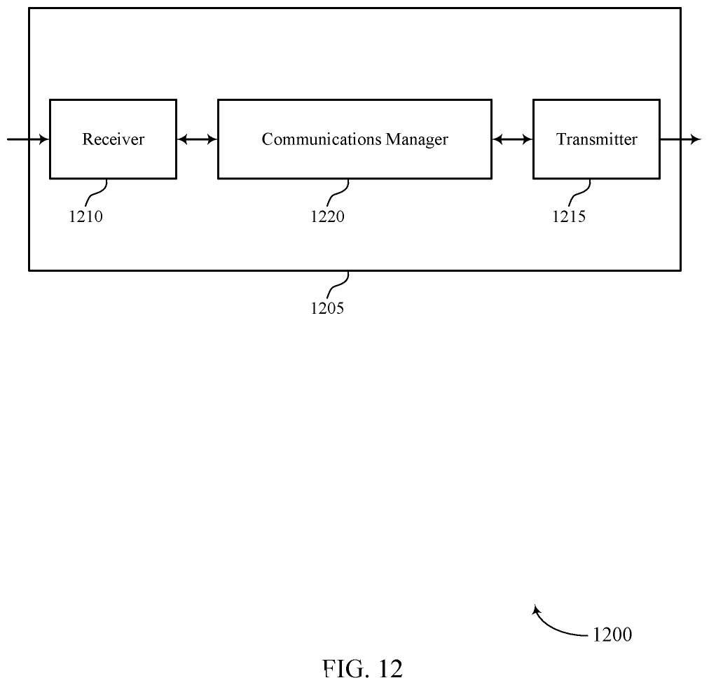

FIG. 12 shows a block diagram 1200 of a device 1205 that supports time-domain variation for sidelink reference signal transmission in accordance with aspects of the present disclosure. The device 1205 may be an example of aspects of a base station 105 or a network entity 140 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to time-domain variation for sidelink reference signal transmission). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to time-domain variation for sidelink reference signal transmission). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of time-domain variation for sidelink reference signal transmission as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a base station or a network entity in accordance with examples as disclosed herein. For example, the communications manager 1220 may be configured as or otherwise support a means for obtaining a first request for sidelink resources for a reference signal measurement for a first set of multiple UEs. The communications manager 1220 may be configured as or otherwise support a means for outputting an indication of a periodic set of sidelink resources for the reference signal measurement associated with a one or more reference signals and a time-domain variation associated with the one or more reference signals or the reference signal measurement for each UE of the first set of multiple UEs.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for improving reference signal measurement accuracy in a sidelink system among UEs 115, which may be served (e.g., directly or through a relay UE 115) by the device 1205.

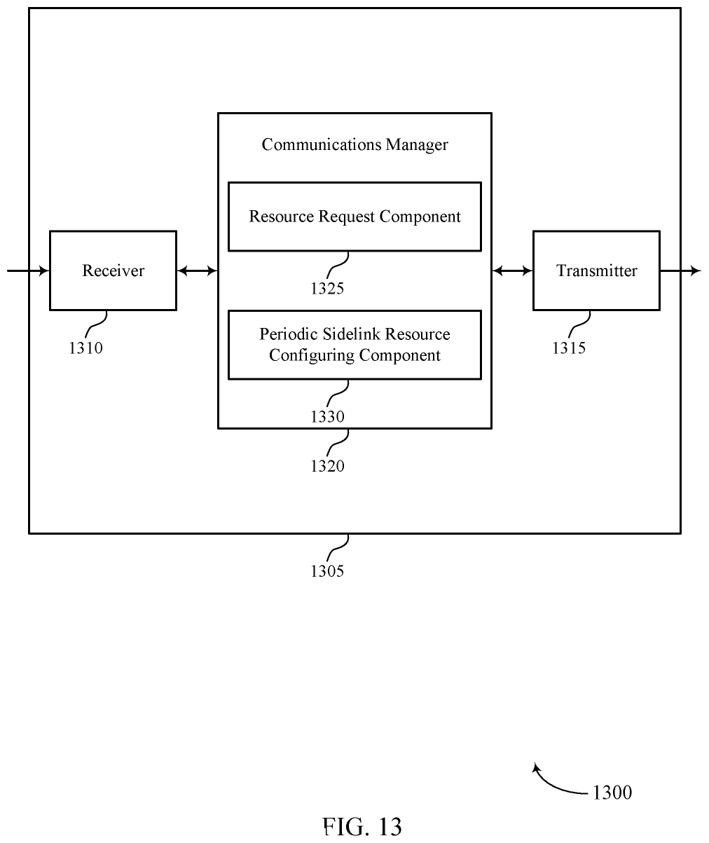

FIG. 13 shows a block diagram 1300 of a device 1305 that supports time-domain variation for sidelink reference signal transmission in accordance with aspects of the present disclosure. The device 1305 may be an example of aspects of a device 1205, a base station 105, or a network entity 140 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to time-domain variation for sidelink reference signal transmission). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to time-domain variation for sidelink reference signal transmission). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of time-domain variation for sidelink reference signal transmission as described herein. For example, the communications manager 1320 may include a resource request component 1325 a periodic sidelink resource configuring component 1330, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station or a network entity in accordance with examples as disclosed herein. The resource request component 1325 may be configured as or otherwise support a means for obtaining, for example from a first UE, a first request for sidelink resources for a reference signal measurement for a first set of multiple UEs. The periodic sidelink resource configuring component 1330 may be configured as or otherwise support a means for outputting, for example to the first UE, an indication of a periodic set of sidelink resources for the reference signal measurement associated with one or more reference signals and a time-domain variation associated with the one or more reference signals or the reference signal measurement for each UE of the first set of multiple UEs.

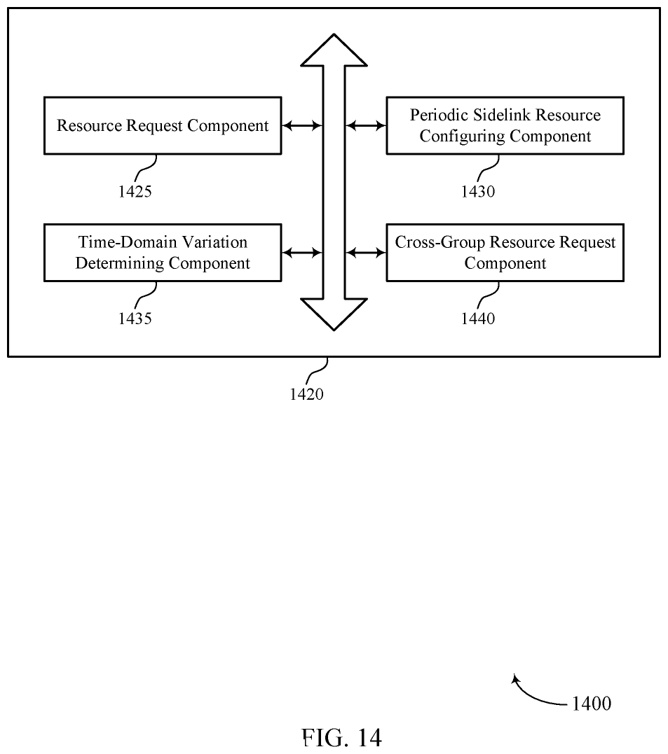

FIG. 14 shows a block diagram 1400 of a communications manager 1420 that supports time-domain variation for sidelink reference signal transmission in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of time-domain variation for sidelink reference signal transmission as described herein. For example, the communications manager 1420 may include a resource request component 1425, a periodic sidelink resource configuring component 1430, a time-domain variation determining component 1435, a cross-group resource request component 1440, or any combination thereof. Each of these components may communicate, directly or indirectly, with one another (e.g., via one or more buses).

The communications manager 1420 may support wireless communications at a base station or a network entity in accordance with examples as disclosed herein. The resource request component 1425 may be configured as or otherwise support a means for obtaining a first request for sidelink resources for a reference signal measurement for a first set of multiple UEs. The periodic sidelink resource configuring component 1430 may be configured as or otherwise support a means for outputting an indication of a periodic set of sidelink resources for the reference signal measurement associated with one or more reference signals and a time-domain variation associated with the one or more reference signals or the reference signal measurement for each UE of the first set of multiple UEs.

In some examples, the time-domain variation determining component 1435 may be configured as or otherwise support a means for determining the time-domain variation based on an offset cyclic shift for the reference signal measurement and a time-domain offset in a first sidelink resource of the periodic set of sidelink resources for each UE of the first set of multiple UEs. In some examples, the periodic sidelink resource configuring component 1430 may be configured as or otherwise support a means for outputting an indication of the offset cyclic shift for the reference signal measurement and the time-domain offset in the first sidelink resource of the periodic set of sidelink resources for each UE of the first set of multiple UEs.

In some examples, the time-domain variation determining component 1435 may be configured as or otherwise support a means for determining the time-domain variation based on a sequence of time-domain offsets corresponding to each sidelink resource of the periodic set of sidelink resources for each UE of the first set of multiple UEs. In some examples, the periodic sidelink resource configuring component 1430 may be configured as or otherwise support a means for outputting an indication of the sequence of time-domain offsets and a periodicity for the periodic set of sidelink resources.

In some examples, the periodic sidelink resource configuring component 1430 may be configured as or otherwise support a means for outputting an indication of a pseudo-random sequence, where the sequence of time-domain offsets are determined based on the pseudo-random sequence and corresponding UE identifiers for each UE of the first set of multiple UEs.

In some examples, the time-domain variation determining component 1435 may be configured as or otherwise support a means for determining a non-repeating hopping pattern across the periodic set of sidelink resources for each UE of the first set of multiple UEs, where a UE of the first set of multiple UEs is scheduled to communicate in each transmission time interval index of a plurality of transmission time interval indexes of a sidelink resource over the periodic set of sidelink resources before repeating transmission on any transmission time interval index of the plurality of transmission time interval indexes.

In some examples, the non-repeating hopping pattern is determined based on a UE identifier, a relay identifier, a source device identifier, a destination device identifier, or any combination thereof.

In some examples, the cross-group resource request component 1440 may be configured as or otherwise support a means for obtaining a second request, for example from a second UE, for a second sidelink resources for the reference signal measurement for a second set of multiple UEs, where the periodic set of sidelink resources for the reference signal measurement and the time-domain variation are based on the second request and the second set of multiple UEs.

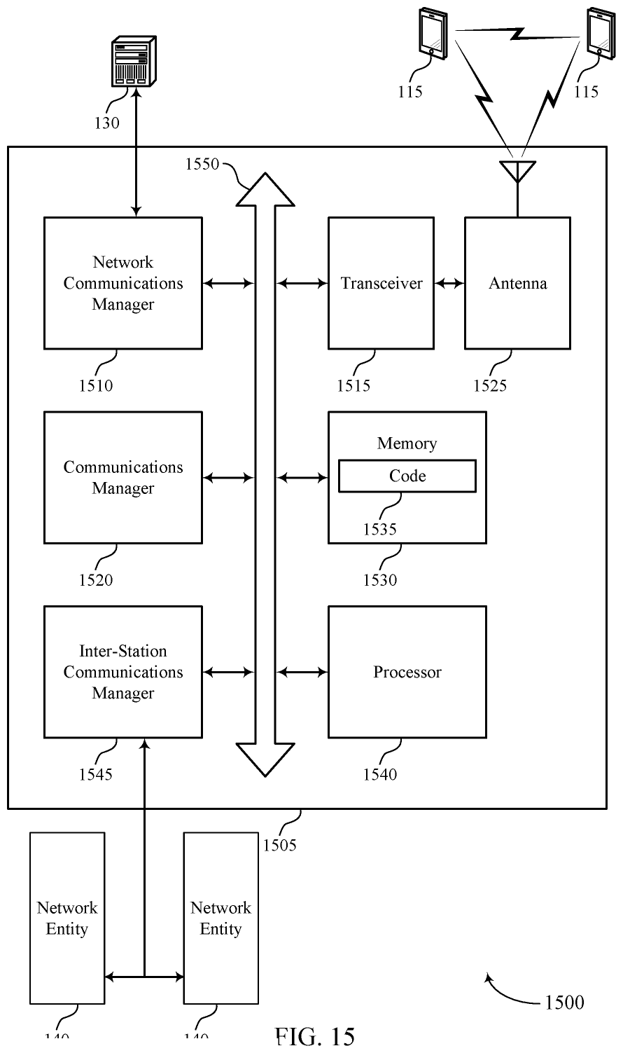

FIG. 15 shows a diagram of a system 1500 including a device 1505 that supports time-domain variation for sidelink reference signal transmission in accordance with aspects of the present disclosure. The device 1505 may be an example of or include the components of a device 1205, a device 1305, a base station 105, or a network entity 140 as described herein. The device 1505 may communicate wirelessly with one or more base stations 105, UEs 115, network entities 140, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting time-domain variation for sidelink reference signal transmission). For example, the device 1505 or a component of the device 1505 may include a processor 1540 and memory 1530 coupled with the processor 1540, the processor 1540 and memory 1530 configured to perform various functions described herein.

The inter-station communications manager 1545 may manage communications with other base stations 105 or network entities 140, and may include a controller or scheduler for controlling communications with UEs 115 in cooperation with other base stations 105 or network entities 140. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105 or network entities 140.

The communications manager 1520 may support wireless communications at a base station or a network entity in accordance with examples as disclosed herein. For example, the communications manager 1520 may be configured as or otherwise support a means for obtaining a first request for sidelink resources for a reference signal measurement for a first set of multiple UEs. The communications manager 1520 may be configured as or otherwise support a means for outputting an indication of a periodic set of sidelink resources for the reference signal measurement associated with one or more reference signals and a time-domain variation associated with the one or more reference signals or the reference signal measurement for each UE of the first set of multiple UEs.

By including or configuring the communications manager 1520 in accordance with examples as described herein, the device 1505 may support techniques for improving reference signal measurement performance while prevent reference signal resource collisions.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of time-domain variation for sidelink reference signal transmission as described herein, or the processor 1540 and the memory 1530 may be otherwise configured to perform or support such operations.

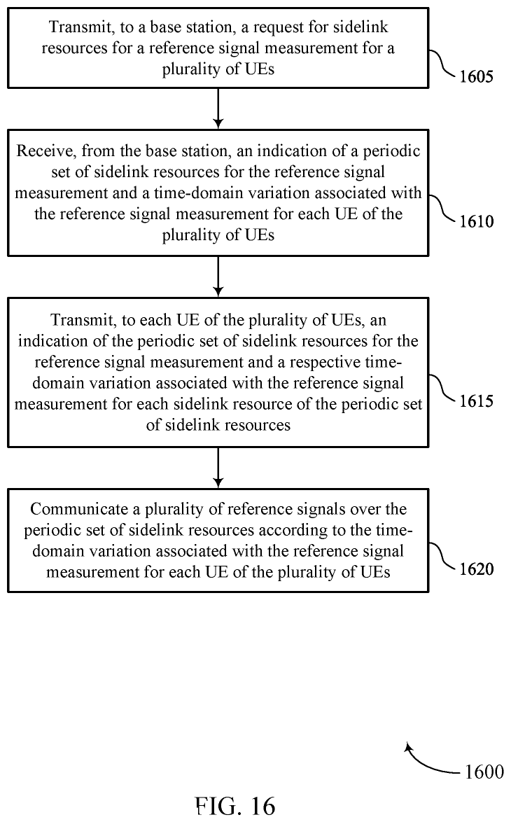

FIG. 16 shows a flowchart illustrating a method 1600 that supports time-domain variation for sidelink reference signal transmission in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include transmitting, to a base station or a network entity, a request for sidelink resources for a reference signal measurement for a set of multiple UEs. The operations of 1605 may be performed in accordance with examples as disclosed herein. In some examples, aspects of the operations of 1605 may be performed by a sidelink resource request component 1025 as described with reference to FIG. 10.

At 1610, the method may include receiving, from the base station or a network entity, an indication of a periodic set of sidelink resources for the reference signal measurement and a time-domain variation associated with the reference signal measurement for each UE of the set of multiple UEs. The operations of 1610 may be performed in accordance with examples as disclosed herein. In some examples, aspects of the operations of 1610 may be performed by a sidelink resource configuration receiving component 1030 as described with reference to FIG. 10.

At 1615, the method may include transmitting, to each UE of the set of multiple UEs, an indication of the periodic set of sidelink resources for the reference signal measurement and a respective time-domain variation associated with the reference signal measurement for each sidelink resource of the periodic set of sidelink resources. The operations of 1615 may be performed in accordance with examples as disclosed herein. In some examples, aspects of the operations of 1615 may be performed by a reference signal procedure configuration component 1035 as described with reference to FIG. 10.

At 1620, the method may include communicating a set of multiple reference signals over the periodic set of sidelink resources according to the time-domain variation associated with the reference signal measurement for each UE of the set of multiple UEs. The operations of 1620 may be performed in accordance with examples as disclosed herein. In some examples, aspects of the operations of 1620 may be performed by a reference signal communication component 1040 as described with reference to FIG. 10.

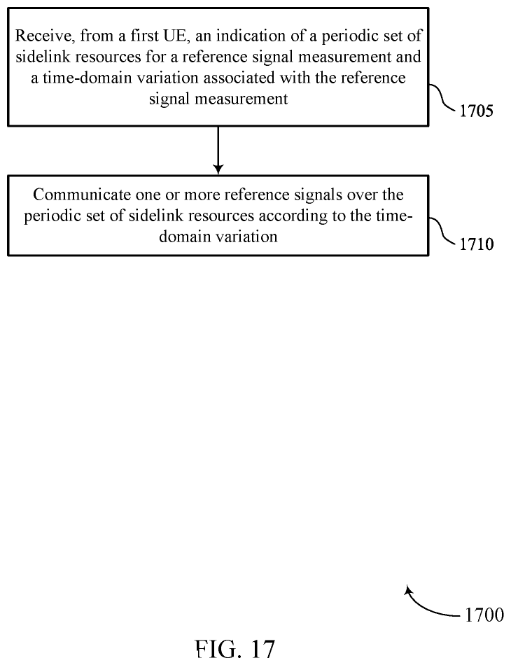

FIG. 17 shows a flowchart illustrating a method 1700 that supports time-domain variation for sidelink reference signal transmission in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include receiving, from a first UE, an indication of a periodic set of sidelink resources for a reference signal measurement and a time-domain variation associated with the reference signal measurement. The operations of 1705 may be performed in accordance with examples as disclosed herein. In some examples, aspects of the operations of 1705 may be performed by a reference signal procedure configuration component 1035 as described with reference to FIG. 10.

At 1710, the method may include communicating one or more reference signals over the periodic set of sidelink resources according to the time-domain variation. The operations of 1710 may be performed in accordance with examples as disclosed herein. In some examples, aspects of the operations of 1710 may be performed by a reference signal communication component 1040 as described with reference to FIG. 10.

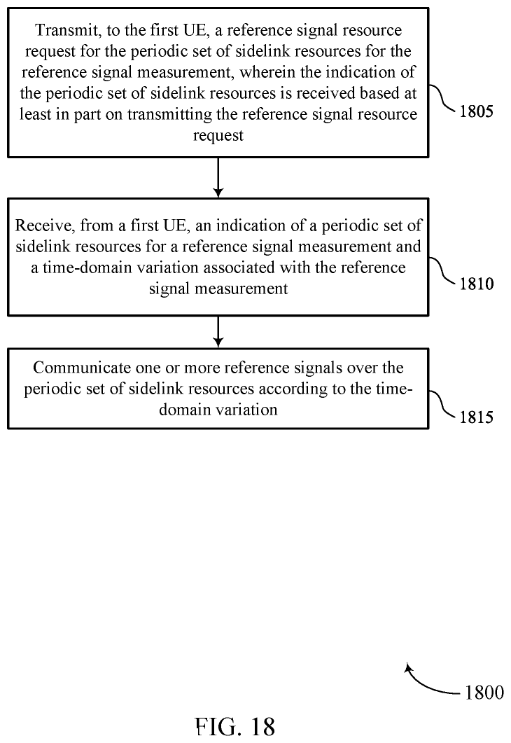

FIG. 18 shows a flowchart illustrating a method 1800 that supports time-domain variation for sidelink reference signal transmission in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include transmitting, to the first UE, a reference signal resource request for the periodic set of sidelink resources for the reference signal measurement, where the indication of the periodic set of sidelink resources is received based on transmitting the reference signal resource request. The operations of 1805 may be performed in accordance with examples as disclosed herein. In some examples, aspects of the operations of 1805 may be performed by a reference signal request component 1050 as described with reference to FIG. 10.

At 1810, the method may include receiving, from a first UE, an indication of a periodic set of sidelink resources for a reference signal measurement and a time-domain variation associated with the reference signal measurement. The operations of 1810 may be performed in accordance with examples as disclosed herein. In some examples, aspects of the operations of 1810 may be performed by a reference signal procedure configuration component 1035 as described with reference to FIG. 10.

At 1815, the method may include communicating one or more reference signals over the periodic set of sidelink resources according to the time-domain variation. The operations of 1815 may be performed in accordance with examples as disclosed herein. In some examples, aspects of the operations of 1815 may be performed by a reference signal communication component 1040 as described with reference to FIG. 10.

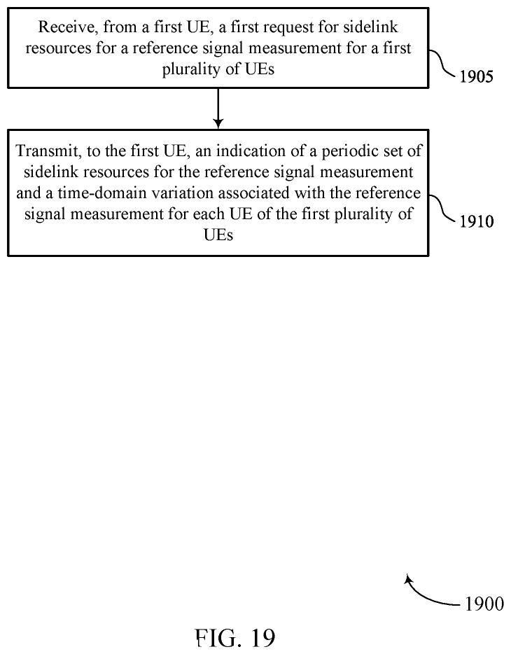

FIG. 19 shows a flowchart illustrating a method 1900 that supports time-domain variation for sidelink reference signal transmission in accordance with aspects of the present disclosure. The operations of the method 1900 may be implemented by a base station or its components, or a network entity 140 as described herein. For example, the operations of the method 1900 may be performed by a base station 105 or a network entity 140 as described with reference to FIGS. 1 through 7 and 12 through 15. In some examples, a base station or network entity may execute a set of instructions to control the functional elements of the base station or network entity to perform the described functions. Additionally or alternatively, the base station or network entity may perform aspects of the described functions using special-purpose hardware.

At 1905, the method may include receiving, from a first UE, a first request for sidelink resources for a reference signal measurement for a first set of multiple UEs. The operations of 1905 may be performed in accordance with examples as disclosed herein. In some examples, aspects of the operations of 1905 may be performed by a resource request component 1425 as described with reference to FIG. 14.

At 1910, the method may include transmitting, to the first UE, an indication of a periodic set of sidelink resources for the reference signal measurement and a time-domain variation associated with the reference signal measurement for each UE of the first set of multiple UEs. The operations of 1910 may be performed in accordance with examples as disclosed herein. In some examples, aspects of the operations of 1910 may be performed by a periodic sidelink resource configuring component 1430 as described with reference to FIG. 14.

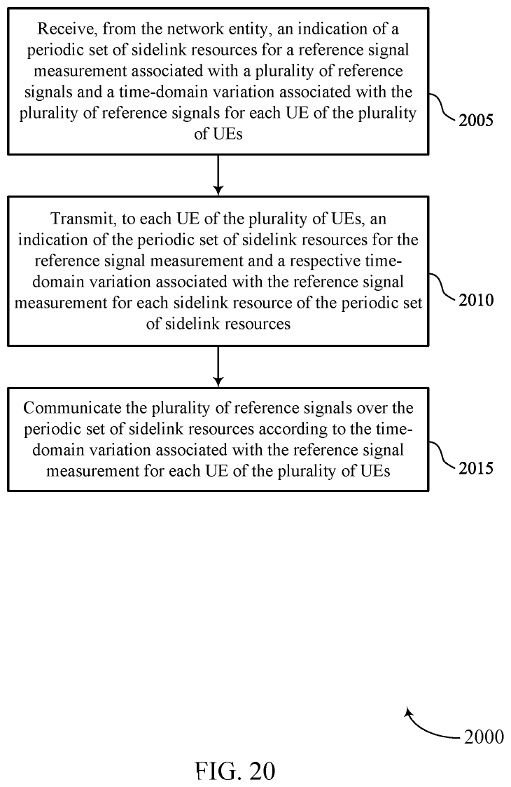

FIG. 20 shows a flowchart illustrating a method 2000 that supports time-domain variation for sidelink reference signal transmission in accordance with aspects of the present disclosure. The operations of the method 2000 may be implemented by a UE or its components as described herein. For example, the operations of the method 2000 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 2005, the method may include receiving, from a network entity, an indication of a periodic set of sidelink resources for the reference signal measurement associated with a set of multiple reference signals and a time-domain variation associated with the set of multiple reference signals for each UE of the set of multiple UEs. The operations of 2005 may be performed in accordance with examples as disclosed herein. In some examples, aspects of the operations of 2005 may be performed by a sidelink resource configuration receiving component 1030 as described with reference to FIG. 10.

At 2010, the method may include transmitting, to each UE of the set of multiple UEs, an indication of the periodic set of sidelink resources for the reference signal measurement and a respective time-domain variation associated with the set of multiple reference signals for each sidelink resource of the periodic set of sidelink resources. The operations of 2010 may be performed in accordance with examples as disclosed herein. In some examples, aspects of the operations of 2010 may be performed by a reference signal procedure configuration component 1035 as described with reference to FIG. 10.

At 2015, the method may include communicating the set of multiple reference signals over the periodic set of sidelink resources according to the time-domain variation associated with the set of multiple reference signals for each UE of the set of multiple UEs. The operations of 2015 may be performed in accordance with examples as disclosed herein. In some examples, aspects of the operations of 2015 may be performed by a reference signal communication component 1040 as described with reference to FIG. 10.

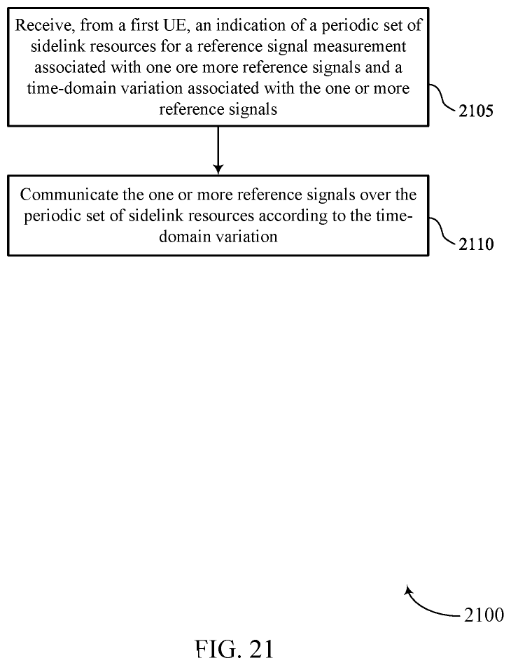

FIG. 21 shows a flowchart illustrating a method 2100 that supports time-domain variation for sidelink reference signal transmission in accordance with aspects of the present disclosure. The operations of the method 2100 may be implemented by a UE or its components as described herein. For example, the operations of the method 2100 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 2105, the method may include receiving, from a first UE, an indication of a periodic set of sidelink resources for a reference signal measurement one or more reference signals and a time-domain variation associated with the one or more reference signals. The operations of 2105 may be performed in accordance with examples as disclosed herein. In some examples, aspects of the operations of 2105 may be performed by a reference signal procedure configuration component 1035 as described with reference to FIG. 10.

At 2110, the method may include communicating the one or more reference signals over the periodic set of sidelink resources according to the time-domain variation. The operations of 2110 may be performed in accordance with examples as disclosed herein. In some examples, aspects of the operations of 2110 may be performed by a reference signal communication component 1040 as described with reference to FIG. 10.

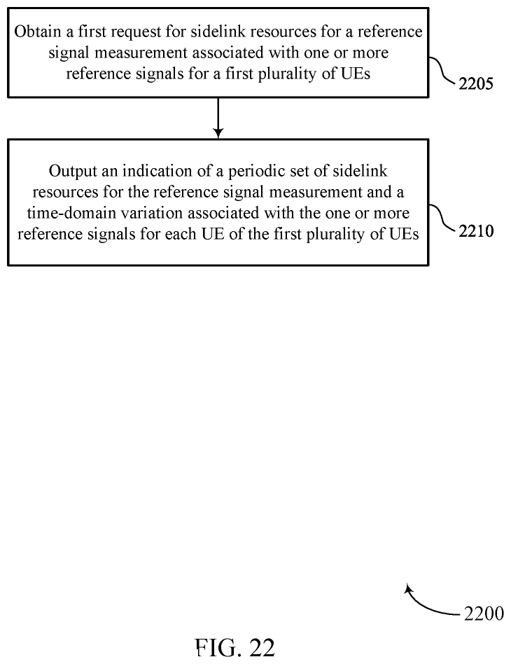

FIG. 22 shows a flowchart illustrating a method 2200 that supports time-domain variation for sidelink reference signal transmission in accordance with aspects of the present disclosure. The operations of the method 2200 may be implemented by a base station or its components, or a network entity 140 as described herein. For example, the operations of the method 2200 may be performed by a base station 105 or a network entity 140 as described with reference to FIGS. 1 through 7 and 12 through 15. In some examples, a base station or network entity may execute a set of instructions to control the functional elements of the base station or network entity to perform the described functions. Additionally or alternatively, the base station or network entity may perform aspects of the described functions using special-purpose hardware.

At 2205, the method may include obtaining a first request for sidelink resources for a reference signal measurement associated with one or more reference signals for a first set of multiple UEs. The operations of 2205 may be performed in accordance with examples as disclosed herein. In some examples, aspects of the operations of 2205 may be performed by a resource request component 1425 as described with reference to FIG. 14.

At 2210, the method may include outputting an indication of a periodic set of sidelink resources for the reference signal measurement and a time-domain variation associated with the one or more reference signals for each UE of the first set of multiple UEs. The operations of 2210 may be performed in accordance with examples as disclosed herein. In some examples, aspects of the operations of 2210 may be performed by a periodic sidelink resource configuring component 1430 as described with reference to FIG. 14.

The following provides an overview of aspects of the present disclosure:

Aspect 1: A method for wireless communications at a first UE, comprising: transmitting, to a base station, a request for sidelink resources for a reference signal measurement for a plurality of UEs; receiving, from the base station, an indication of a periodic set of sidelink resources for the reference signal measurement and a time-domain variation associated with the reference signal measurement for each UE of the plurality of UEs; transmitting, to each UE of the plurality of UEs, an indication of the periodic set of sidelink resources for the reference signal measurement and a respective time-domain variation associated with the reference signal measurement for each sidelink resource of the periodic set of sidelink resources; and communicating a plurality of reference signals over the periodic set of sidelink resources according to the time-domain variation associated with the reference signal measurement for each UE of the plurality of UEs.

Aspect 2: The method of aspect 1, the receiving the indication of the periodic set of sidelink resources comprising: receiving an associated time-domain offset for each UE of the plurality of UEs in a first sidelink resource of the periodic set of sidelink resources; and determining, based at least in part on the time-domain variation, an offset cyclic shift for the reference signal measurement, the communicating the plurality of reference signals being based at least in part on the associated time-domain offset for each UE of the plurality of UEs and the offset cyclic shift for the reference signal measurement.

Aspect 3: The method of aspect 1, the receiving the indication of the periodic set of sidelink resources comprising: receiving an indication of a periodicity for the periodic set of sidelink resources; and determining, based at least in part on the time-domain variation, a sequence of time-domain offsets corresponding to each sidelink resource of the periodic set of sidelink resources for each UE of the plurality of UEs, the communicating the plurality of reference signals being based at least in part on the periodicity for the periodic set of sidelink resources and the sequence of time-domain offsets.

Aspect 4: The method of aspect 3, further comprising: transmitting, to each UE of the plurality of UEs, an indication of a pseudo-random sequence, wherein the sequence of time-domain offsets are determined based at least in part on the pseudo-random sequence and corresponding UE identifiers for each UE of the plurality of UEs.

Aspect 5: The method of aspect 1, further comprising: determining a non-repeating hopping pattern across the periodic set of sidelink resources for each UE of the plurality of UEs, wherein a UE of the plurality of UEs is scheduled to communicate in each transmission time interval index over the periodic set of sidelink resources before repeating any transmission time interval index.

Aspect 6: The method of aspect 5, wherein the non-repeating hopping pattern is determined based at least in part on a UE identifier, a relay identifier, a source device identifier, a destination device identifier, or any combination thereof.

Aspect 7: The method of any of aspects 1 through 6, further comprising: receiving, from a second UE of the plurality of UEs, a reference signal resource request for the sidelink resources for the reference signal measurement, wherein the request for the sidelink resources is transmitted to the base station based at least in part on receiving the reference signal resource request from the second UE.

Aspect 8: The method of any of aspects 1 through 7, the indicating the periodic set of sidelink resources for the reference signal measurement comprising: broadcasting an indication of the periodic set of sidelink resources including a periodicity for the periodic set of sidelink resources and the time-domain variation associated with the reference signal measurement.

Aspect 9: The method of any of aspects 1 through 8, the communicating the plurality of reference signals comprising: transmitting the plurality of reference signals over the periodic set of sidelink resources according to the time-domain variation associated with the reference signal measurement for each UE of the plurality of UEs.

Aspect 10: The method of any of aspects 1 through 9, the communicating the plurality of reference signals comprising: monitoring for the plurality of reference signals over the periodic set of sidelink resources according to the time-domain variation associated with the reference signal measurement for each UE of the plurality of UEs.

Aspect 11: The method of any of aspects 1 through 10, wherein the reference signal measurement is a sidelink CSI-RS measurement, a sidelink PRS measurement, an SRS measurement, or any combination thereof.

Aspect 12: A method for wireless communications at a second UE, comprising: receiving, from a first UE, an indication of a periodic set of sidelink resources for a reference signal measurement and a time-domain variation associated with the reference signal measurement; and communicating one or more reference signals over the periodic set of sidelink resources according to the time-domain variation.

Aspect 13: The method of aspect 12, the receiving the indication of the periodic set of sidelink resources comprising: receiving an indication of a time-domain offset for a first sidelink resource of the periodic set of sidelink resources and an offset cyclic shift for the reference signal measurement over the periodic set of sidelink resources, the communicating the one or more reference signals being based at least in part on the time-domain offset and the offset cyclic shift for the reference signal measurement.

Aspect 14: The method of aspect 12, the receiving the indication of the periodic set of sidelink resources comprising: receiving an indication of a periodicity for the periodic set of sidelink resources and a sequence of time-domain offsets corresponding to each sidelink resource of the periodic set of sidelink resources, the communicating the one or more reference signals being based at least in part on the periodicity for the periodic set of sidelink resources and the sequence of time-domain offsets.

Aspect 15: The method of aspect 14, further comprising: receiving an indication of a pseudo-random sequence, wherein the sequence of time-domain offsets are determined based at least in part on the pseudo-random sequence and a UE identifier for the second UE.

Aspect 16: The method of aspect 12, further comprising: determining a non-repeating hopping pattern across the periodic set of sidelink resources, wherein the second UE is scheduled to communicate in each transmission time interval index over the periodic set of sidelink resources before repeating any transmission time interval index.

Aspect 17: The method of aspect 16, wherein the non-repeating hopping pattern is determined based at least in part on a UE identifier, a relay identifier, a source device identifier, a destination device identifier, or any combination thereof.

Aspect 18: The method of any of aspects 12 through 17, further comprising: transmitting, to the first UE, a reference signal resource request for the periodic set of sidelink resources for the reference signal measurement, wherein the indication of the periodic set of sidelink resources is received based at least in part on transmitting the reference signal resource request.

Aspect 19: The method of any of aspects 12 through 18, the communicating the one or more reference signals comprising: monitoring for the one or more reference signals over the periodic set of sidelink resources according to the time-domain variation associated with the reference signal measurement.

Aspect 20: The method of any of aspects 12 through 19, the communicating the one or more reference signals comprising: transmitting the one or more reference signals over the periodic set of sidelink resources according to the time-domain variation associated with the reference signal measurement.

Aspect 21: A method for wireless communications at a base station, comprising: receiving, from a first UE, a first request for sidelink resources for a reference signal measurement for a first plurality of UEs; and transmitting, to the first UE, an indication of a periodic set of sidelink resources for the reference signal measurement and a time-domain variation associated with the reference signal measurement for each UE of the first plurality of UEs.

Aspect 22: The method of aspect 21, the transmitting the indication of the periodic set of sidelink resources comprising: determining the time-domain variation based at least in part on an offset cyclic shift for the reference signal measurement and a time-domain offset in a first sidelink resource of the periodic set of sidelink resources for each UE of the first plurality of UEs; and transmitting an indication of the offset cyclic shift for the reference signal measurement and the time-domain offset in the first sidelink resource of the periodic set of sidelink resources for each UE of the first plurality of UEs.

Aspect 23: The method of aspect 21, the transmitting the indication of the periodic set of sidelink resources comprising: determining the time-domain variation based at least in part on a sequence of time-domain offsets corresponding to each sidelink resource of the periodic set of sidelink resources for each UE of the first plurality of UEs; and transmitting an indication of the sequence of time-domain offsets and a periodicity for the periodic set of sidelink resources.

Aspect 24: The method of aspect 23, further comprising: transmitting, to the first UE, an indication of a pseudo-random sequence, wherein the sequence of time-domain offsets are determined based at least in part on the pseudo-random sequence and corresponding UE identifiers for each UE of the first plurality of UEs.

Aspect 25: The method of aspect 21, further comprising: determining a non-repeating hopping pattern across the periodic set of sidelink resources for each UE of the first plurality of UEs, wherein a UE of the first plurality of UEs is scheduled to communicate in each transmission time interval index of a sidelink resource over the periodic set of sidelink resources before repeating any transmission time interval index.

Aspect 26: The method of aspect 25, wherein the non-repeating hopping pattern is determined based at least in part on a UE identifier, a relay identifier, a source device identifier, a destination device identifier, or any combination thereof.

Aspect 27: The method of any of aspects 21 through 26, further comprising: receiving a second request from a second UE for a second sidelink resources for the reference signal measurement for a second plurality of UEs, wherein the periodic set of sidelink resources for the reference signal measurement and the time-domain variation are based at least in part on the second request and the second plurality of UEs.

Aspect 28: A method for wireless communications at a first UE, comprising: receiving, from a network entity, an indication of a periodic set of sidelink resources for a reference signal measurement associated with a plurality of reference signals and a time-domain variation associated with the plurality of reference signals for each UE of a plurality of UEs; transmitting, to each UE of the plurality of UEs, an indication of the periodic set of sidelink resources for the reference signal measurement and a respective time-domain variation associated with the plurality of reference signals for each sidelink resource of the periodic set of sidelink resources; and communicating the plurality of reference signals over the periodic set of sidelink resources according to the time-domain variation associated with the plurality of reference signals for each UE of the plurality of UEs.

Aspect 29: The method of aspect 28, the receiving the indication of the periodic set of sidelink resources comprising: receiving an associated time-domain offset for each UE of the plurality of UEs in a first sidelink resource of the periodic set of sidelink resources; and determining, based at least in part on the time-domain variation, an offset cyclic shift for the reference signal measurement, the communicating the plurality of reference signals being based at least in part on the associated time-domain offset for each UE of the plurality of UEs and the offset cyclic shift for the reference signal measurement.

Aspect 30: The method of aspect 28, the receiving the indication of the periodic set of sidelink resources comprising: receiving an indication of a periodicity for the periodic set of sidelink resources; and determining, based at least in part on the time-domain variation, a sequence of time-domain offsets corresponding to each sidelink resource of the periodic set of sidelink resources for each UE of the plurality of UEs, the communicating the plurality of reference signals being based at least in part on the periodicity for the periodic set of sidelink resources and the sequence of time-domain offsets.

Aspect 31: The method of aspect 30, further comprising: transmitting, to each UE of the plurality of UEs, an indication of a pseudo-random sequence, wherein the sequence of time-domain offsets are determined based at least in part on the pseudo-random sequence and corresponding UE identifiers for each UE of the plurality of UEs.

Aspect 32: The method of aspect 28, further comprising: determining a non-repeating hopping pattern across the periodic set of sidelink resources for each UE of the plurality of UEs, wherein a UE of the plurality of UEs is scheduled to communicate in each transmission time interval index of a plurality of transmission time interval indexes once over the periodic set of sidelink resources before repeating transmission on any transmission time interval index of the plurality of transmission time interval indexes.

Aspect 33: The method of aspect 32, wherein the non-repeating hopping pattern is determined based at least in part on a UE identifier, a relay identifier, a source device identifier, a destination device identifier, or any combination thereof.

Aspect 34: The method of any of aspects 28 through 33, further comprising: receiving, from a second UE of the plurality of UEs, a reference signal resource request for the sidelink resources for the reference signal measurement; and transmitting, to the network entity, a request for sidelink resources for the reference signal measurement for the plurality of UEs based at least in part on receiving the reference signal resource request from the second UE.

Aspect 35: The method of any of aspects 28 through 34, the indicating the periodic set of sidelink resources for the reference signal measurement comprising: broadcasting an indication of the periodic set of sidelink resources including a periodicity for the periodic set of sidelink resources and the time-domain variation associated with the plurality of reference signals.

Aspect 36: The method of any of aspects 28 through 35, the communicating the plurality of reference signals comprising: transmitting the plurality of reference signals over the periodic set of sidelink resources according to the time-domain variation associated with the plurality of reference signals for each UE of the plurality of UEs.

Aspect 37: The method of any of aspects 28 through 36, the communicating the plurality of reference signals comprising: monitoring for the plurality of reference signals over the periodic set of sidelink resources according to the time-domain variation associated with the plurality of reference signals for each UE of the plurality of UEs.

Aspect 38: The method of any of aspects 28 through 37, wherein the reference signal measurement is a sidelink CSI CSI-RS measurement, a sidelink PRS measurement, an SRS measurement, or any combination thereof.

Aspect 39: A method for wireless communications at a second UE, comprising: receiving, from a first UE, an indication of a periodic set of sidelink resources for a reference signal measurement associated with one or more reference signals and a time-domain variation associated with the one or more reference signals; and communicating the one or more reference signals over the periodic set of sidelink resources according to the time-domain variation.

Aspect 40: The method of aspect 39, the receiving the indication of the periodic set of sidelink resources comprising: receiving an indication of a time-domain offset for a first sidelink resource of the periodic set of sidelink resources and an offset cyclic shift for the reference signal measurement over the periodic set of sidelink resources, the communicating the one or more reference signals being based at least in part on the time-domain offset and the offset cyclic shift for the reference signal measurement.

Aspect 41: The method of aspect 39, the receiving the indication of the periodic set of sidelink resources comprising: receiving an indication of a periodicity for the periodic set of sidelink resources and a sequence of time-domain offsets corresponding to each sidelink resource of the periodic set of sidelink resources, the communicating the one or more reference signals being based at least in part on the periodicity for the periodic set of sidelink resources and the sequence of time-domain offsets.

Aspect 42: The method of aspect 41, further comprising: receiving an indication of a pseudo-random sequence, wherein the sequence of time-domain offsets are determined based at least in part on the pseudo-random sequence and a UE identifier for the second UE.

Aspect 43: The method of aspect 39, further comprising: determining a non-repeating hopping pattern across the periodic set of sidelink resources, wherein the second UE is scheduled to communicate in each transmission time interval index of a plurality of transmission time interval indexes once over the periodic set of sidelink resources before repeating transmission on any transmission time interval index of the plurality of transmission time indexes.

Aspect 44: The method of aspect 43, wherein the non-repeating hopping pattern is determined based at least in part on a UE identifier, a relay identifier, a source device identifier, a destination device identifier, or any combination thereof.

Aspect 45: The method of any of aspects 39 through 44, further comprising: transmitting, to the first UE, a reference signal resource request for the periodic set of sidelink resources for the reference signal measurement, wherein the indication of the periodic set of sidelink resources is received based at least in part on transmitting the reference signal resource request.

Aspect 46: The method of any of aspects 39 through 45, the communicating the one or more reference signals comprising: monitoring for the one or more reference signals over the periodic set of sidelink resources according to the time-domain variation associated with the one or more reference signals.

Aspect 47: The method of any of aspects 39 through 46, the communicating the one or more reference signals comprising: transmitting the one or more reference signals over the periodic set of sidelink resources according to the time-domain variation associated with the one or more reference signals.

Aspect 48: A method for wireless communications at a network entity, comprising: obtaining a first request for sidelink resources for a reference signal measurement for a first plurality of UEs; and outputting an indication of a periodic set of sidelink resources for the reference signal measurement associated with a plurality of reference signals and a time-domain variation associated with the plurality of reference signals for each UE of the first plurality of UEs.

Aspect 49: The method of aspect 48, the outputting the indication of the periodic set of sidelink resources comprising: determining the time-domain variation based at least in part on an offset cyclic shift for the reference signal measurement and a time-domain offset in a first sidelink resource of the periodic set of sidelink resources for each UE of the first plurality of UEs; and outputting an indication of the offset cyclic shift for the reference signal measurement and the time-domain offset in the first sidelink resource of the periodic set of sidelink resources for each UE of the first plurality of UEs.

Aspect 50: The method of aspect 48, the outputting the indication of the periodic set of sidelink resources comprising: determining the time-domain variation based at least in part on a sequence of time-domain offsets corresponding to each sidelink resource of the periodic set of sidelink resources for each UE of the first plurality of UEs; and outputting an indication of the sequence of time-domain offsets and a periodicity for the periodic set of sidelink resources.

Aspect 51: The method of aspect 50, further comprising: outputting an indication of a pseudo-random sequence, wherein the sequence of time-domain offsets are determined based at least in part on the pseudo-random sequence and corresponding UE identifiers for each UE of the first plurality of UEs.

Aspect 52: The method of aspect 48, further comprising: determining a non-repeating hopping pattern across the periodic set of sidelink resources for each UE of the first plurality of UEs, wherein a UE of the first plurality of UEs is scheduled to communicate in each transmission time interval index of a plurality of transmission time interval indexes of a sidelink resource once over the periodic set of sidelink resources before repeating transmission on any transmission time interval index of the plurality of transmission time interval indexes.

Aspect 53: The method of aspect 52, wherein the non-repeating hopping pattern is determined based at least in part on a UE identifier, a relay identifier, a source device identifier, a destination device identifier, or any combination thereof.

Aspect 54: The method of any of aspects 48 through 53, further comprising: obtaining a second request from a second UE for a second sidelink resources for the reference signal measurement for a second plurality of UEs, wherein the periodic set of sidelink resources for the reference signal measurement and the time-domain variation are based at least in part on the second request and the second plurality of UEs.

Aspect 55: An apparatus for wireless communications at a first UE, comprising a processor; and memory coupled with the processor, the processor configured to perform a method of any of aspects 1 through 11.

Aspect 56: An apparatus for wireless communications at a first UE, comprising at least one means for performing a method of any of aspects 1 through 11.

Aspect 57: A non-transitory computer-readable medium storing code for wireless communications at a first UE, the code comprising instructions executable by a processor to perform a method of any of aspects 1 through 11.

Aspect 58: An apparatus for wireless communications at a second UE, comprising a processor; and memory coupled with the processor, the processor configured to perform a method of any of aspects 12 through 20.

Aspect 59: An apparatus for wireless communications at a second UE, comprising at least one means for performing a method of any of aspects 12 through 20.

Aspect 60: A non-transitory computer-readable medium storing code for wireless communications at a second UE, the code comprising instructions executable by a processor to perform a method of any of aspects 12 through 20.

Aspect 61: An apparatus for wireless communications at a base station, comprising a processor; and memory coupled with the processor, the processor configured to perform a method of any of aspects 21 through 27.

Aspect 62: An apparatus for wireless communications at a base station, comprising at least one means for performing a method of any of aspects 21 through 27.

Aspect 63: A non-transitory computer-readable medium storing code for wireless communications at a base station, the code comprising instructions executable by a processor to perform a method of any of aspects 21 through 27.

Aspect 64: An apparatus for wireless communications at a first UE, comprising a processor; and memory coupled with the processor, the processor configured to perform a method of any of aspects 28 through 38.

Aspect 65: An apparatus for wireless communications at a first UE, comprising at least one means for performing a method of any of aspects 28 through 38.

Aspect 66: A non-transitory computer-readable medium storing code for wireless communications at a first UE, the code comprising instructions executable by a processor to perform a method of any of aspects 28 through 38.

Aspect 58: An apparatus for wireless communications at a network entity, comprising a processor; and memory coupled with the processor, the processor configured to perform a method of any of aspects 39 through 47.

Aspect 59: An apparatus for wireless communications at a network entity, comprising at least one means for performing a method of any of aspects 39 through 47.

Aspect 60: A non-transitory computer-readable medium storing code for wireless communications at a network entity, the code comprising instructions executable by a processor to perform a method of any of aspects 39 through 47.

Aspect 61: An apparatus for wireless communications at a network entity, comprising a processor; and memory coupled with the processor, the processor configured to perform a method of any of aspects 48 through 54.

Aspect 62: An apparatus for wireless communications at a network entity, comprising at least one means for performing a method of any of aspects 48 through 54.

Aspect 63: A non-transitory computer-readable medium storing code for wireless communications at a network entity, the code comprising instructions executable by a processor to perform a method of any of aspects 48 through 54.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor; and
memory coupled with the processor, the processor configured to:
receive, from a network entity, an indication of a periodic set of sidelink resources for a reference signal measurement associated with a plurality of reference signals and a time-domain variation associated with the plurality of reference signals for each UE of a plurality of UEs;
transmit, to each UE of the plurality of UEs, an indication of the periodic set of sidelink resources for the reference signal measurement and a respective time-domain variation associated with the plurality of reference signals for each sidelink resource of the periodic set of sidelink resources; and
communicate the plurality of reference signals over the periodic set of sidelink resources according to the time-domain variation associated with the plurality of reference signals for each UE of the plurality of UEs.

2. The apparatus of claim 1, further comprising:
an antenna, wherein to receive the indication of the periodic set of sidelink resources, the processor is configured to:
receive, via the antenna, an associated time-domain offset for each UE of the plurality of UEs in a first sidelink resource of the periodic set of sidelink resources; and
determine, based at least in part on the time-domain variation, an offset cyclic shift for the reference signal measurement, wherein the processor is configured to communicate the plurality of reference signals based at least in part on the associated time-domain offset for each UE of the plurality of UEs and the offset cyclic shift for the reference signal measurement.

3. The apparatus of claim 1, wherein, to receive the indication of the periodic set of sidelink resources, the processor is configured to:
receive an indication of a periodicity for the periodic set of sidelink resources; and
determine, based at least in part on the time-domain variation, a sequence of time-domain offsets corresponding to each sidelink resource of the periodic set of sidelink resources for each UE of the plurality of UEs, wherein the processor is configured to communicate the plurality of reference signals based at least in part on the periodicity for the periodic set of sidelink resources and the sequence of time-domain offsets.

4. The apparatus of claim 3, wherein the processor is further configured to:
transmit, to each UE of the plurality of UEs, an indication of a pseudo-random sequence, wherein the sequence of time-domain offsets are determined based at least in part on the pseudo-random sequence and corresponding UE identifiers for each UE of the plurality of UEs.

5. The apparatus of claim 1, wherein the processor is further configured to:
determine a non-repeating hopping pattern across the periodic set of sidelink resources for each UE of the plurality of UEs, wherein a UE of the plurality of UEs is scheduled to communicate in each transmission time interval index of a plurality of transmission time interval indexes once over the periodic set of sidelink resources before repeating transmission on any transmission time interval index of the plurality of transmission time interval indexes.

6. The apparatus of claim 5, wherein the non-repeating hopping pattern is determined based at least in part on a UE identifier, a relay identifier, a source device identifier, a destination device identifier, or any combination thereof.

7. The apparatus of claim 1, wherein the processor is further configured to:
receive, from a second UE of the plurality of UEs, a reference signal resource request for the sidelink resources for the reference signal measurement; and
transmit, to the network entity, a request for sidelink resources for the reference signal measurement for the plurality of UEs based at least in part on the processor being configured to receive the reference signal resource request from the second UE.

8. The apparatus of claim 1, wherein, to indicate the periodic set of sidelink resources for the reference signal measurement, the processor is configured to:
broadcast an indication of the periodic set of sidelink resources including a periodicity for the periodic set of sidelink resources and the time-domain variation associated with the plurality of reference signals.

9. The apparatus of claim 1, wherein, to communicate the plurality of reference signals, the processor is configured to:
transmit the plurality of reference signals over the periodic set of sidelink resources according to the time-domain variation associated with the plurality of reference signals for each UE of the plurality of UEs.

10. The apparatus of claim 1, wherein, to communicate the plurality of reference signals, the processor is configured to:
monitor for the plurality of reference signals over the periodic set of sidelink resources according to the time-domain variation associated with the plurality of reference signals for each UE of the plurality of UEs.

11. The apparatus of claim 1, wherein the reference signal measurement is a sidelink channel state information (CSI) reference signal (CSI-RS) measurement, a sidelink positioning reference signal (PRS) measurement, a sounding reference signal (SRS) measurement, or any combination thereof.

12. An apparatus for wireless communications at a second user equipment (UE), comprising:
a processor; and
memory coupled with the processor, the processor configured to:
receive, from a first UE, an indication of a periodic set of sidelink resources for a reference signal measurement associated with one or more reference signals and a time-domain variation associated with the one or more reference signals; and
communicate the one or more reference signals over the periodic set of sidelink resources according to the time-domain variation.

13. The apparatus of claim 12, further comprising:
an antenna, wherein to receive the indication of the periodic set of sidelink resources, the processor is configured to:
receive, via the antenna, an indication of a time-domain offset for a first sidelink resource of the periodic set of sidelink resources and an offset cyclic shift for the reference signal measurement over the periodic set of sidelink resources, wherein the processor is configured to communicate the one or more reference signals based at least in part on the time-domain offset and the offset cyclic shift for the reference signal measurement.

14. The apparatus of claim 12, wherein, to receive the indication of the periodic set of sidelink resources, the processor is configured to:
receive an indication of a periodicity for the periodic set of sidelink resources and a sequence of time-domain offsets corresponding to each sidelink resource of the periodic set of sidelink resources, wherein the processor is configured to communicate the one or more reference signals being at least in part on the periodicity for the periodic set of sidelink resources and the sequence of time-domain offsets.

15. The apparatus of claim 14, wherein the processor is further configured to:
receive an indication of a pseudo-random sequence, wherein the sequence of time-domain offsets are determined based at least in part on the pseudo-random sequence and a UE identifier for the second UE.

16. The apparatus of claim 12, wherein the processor is further configured to:
determine a non-repeating hopping pattern across the periodic set of sidelink resources, wherein the second UE is scheduled to communicate in each transmission time interval index of a plurality of transmission time indexes once over the periodic set of sidelink resources before repeating transmission on any transmission time interval index of the plurality of transmission time indexes.

17. The apparatus of claim 16, wherein the non-repeating hopping pattern is determined based at least in part on a UE identifier, a relay identifier, a source device identifier, a destination device identifier, or any combination thereof.

18. The apparatus of claim 12, wherein the processor is further configured to:
transmit, to the first UE, a reference signal resource request for the periodic set of sidelink resources for the reference signal measurement, wherein the indication of the periodic set of sidelink resources is received based at least in part on transmitting the reference signal resource request.

19. The apparatus of claim 12, wherein, to communicate the one or more reference signals, the processor is configured to:
monitor for the one or more reference signals over the periodic set of sidelink resources according to the time-domain variation associated with the one or more reference signals.

20. The apparatus of claim 12, wherein, to communicate the one or more reference signals, the processor is configured to:
transmit the one or more reference signals over the periodic set of sidelink resources according to the time-domain variation associated with the one or more reference signals.

21. An apparatus for wireless communications at a network entity, comprising:
a processor; and
memory coupled with the processor, the processor configured to:
obtain a first request for sidelink resources for a reference signal measurement associated with one or more reference signals for a first plurality of user equipments (UEs); and
output an indication of a periodic set of sidelink resources for the reference signal measurement and a time-domain variation associated with the one or more reference signals for each UE of the first plurality of UEs.

22. The apparatus of claim 21, further comprising:
an antenna, wherein to output the indication of the periodic set of sidelink resources, the processor is configured to:
determine the time-domain variation based at least in part on an offset cyclic shift for the reference signal measurement and a time-domain offset in a first sidelink resource of the periodic set of sidelink resources for each UE of the first plurality of UEs; and
output, via the antenna, an indication of the offset cyclic shift for the reference signal measurement and the time-domain offset in the first sidelink resource of the periodic set of sidelink resources for each UE of the first plurality of UEs.

23. The apparatus of claim 21, wherein, to output the indication of the periodic set of sidelink resources, the processor is configured to:
determine the time-domain variation based at least in part on a sequence of time-domain offsets corresponding to each sidelink resource of the periodic set of sidelink resources for each UE of the first plurality of UEs; and
output an indication of the sequence of time-domain offsets and a periodicity for the periodic set of sidelink resources.

24. The apparatus of claim 23, wherein the processor is further configured to:
output an indication of a pseudo-random sequence, wherein the sequence of time-domain offsets are determined based at least in part on the pseudo-random sequence and corresponding UE identifiers for each UE of the first plurality of UEs.

25. The apparatus of claim 21, wherein the processor is further configured to:
determine a non-repeating hopping pattern across the periodic set of sidelink resources for each UE of the first plurality of UEs, wherein a UE of the first plurality of UEs is scheduled to communicate in each transmission time interval index of a sidelink resource over the periodic set of sidelink resources before repeating any transmission time interval index.

26. The apparatus of claim 25, wherein the non-repeating hopping pattern is determined based at least in part on a UE identifier, a relay identifier, a source device identifier, a destination device identifier, or any combination thereof.

27. The apparatus of claim 21, wherein the processor is further configured to:
obtain a second request for a second sidelink resources for a second reference signal measurement for a second plurality of UEs, wherein the periodic set of sidelink resources for the reference signal measurement and the time-domain variation are based at least in part on the second request and the second plurality of UEs.

28. A method for wireless communications at a first user equipment (UE), comprising:
receiving, from a network entity, an indication of a periodic set of sidelink resources for a reference signal measurement associated with a plurality of reference signals and a time-domain variation associated with a plurality of reference signals for each UE of a plurality of UEs;
transmitting, to each UE of the plurality of UEs, an indication of the periodic set of sidelink resources for the reference signal measurement and a respective time-domain variation associated with the plurality of reference signals for each sidelink resource of the periodic set of sidelink resources; and
communicating the plurality of reference signals over the periodic set of sidelink resources according to the time-domain variation associated with the plurality of reference signals for each UE of the plurality of UEs.

29. The method of claim 28, the receiving the indication of the periodic set of sidelink resources comprising:
receiving an associated time-domain offset for each UE of the plurality of UEs in a first sidelink resource of the periodic set of sidelink resources; and
determining, based at least in part on the time-domain variation, an offset cyclic shift for the reference signal measurement, the communicating the plurality of reference signals being based at least in part on the associated time-domain offset for each UE of the plurality of UEs and the offset cyclic shift for the reference signal measurement.

30. The method of claim 28, the receiving the indication of the periodic set of sidelink resources comprising:
receiving an indication of a periodicity for the periodic set of sidelink resources; and
determining, based at least in part on the time-domain variation, a sequence of time-domain offsets corresponding to each sidelink resource of the periodic set of sidelink resources for each UE of the plurality of UEs, the communicating the plurality of reference signals being based at least in part on the periodicity for the periodic set of sidelink resources and the sequence of time-domain offsets.
